(19) United States
(12) Patent Application Publication
(10) Pub. No.: US 2015/0079358 A1
(43) Pub. Date: Mar. 19, 2015

(54) INK FOR INKJET RECORDING, IMAGE FORMING METHOD, IMAGE FORMING APPARATUS AND IMAGE FORMED MATERIAL

(71) Applicants: Hiroshi GOTOU, Shizuoka (JP); Hidetoshi FUJII, Shizuoka (JP)

(72) Inventors: Hiroshi GOTOU, Shizuoka (JP); Hidetoshi FUJII, Shizuoka (JP)

(21) Appl. No.: 14/478,318

(22) Filed: Sep. 5, 2014

(30) Foreign Application Priority Data
Sep. 13, 2013 (JP) 2013-190222
Jul. 25, 2014 (JP) 2014-151420

(51) Int. Cl. C09D 11/324; C09D 127/12; C09D 11/322

(52) U.S. Cl. CPC C09D 11/324; C09D 11/322; C09D 127/12
USPC 428/195.1; 106/31.75; 524/107; 106/31.78; 106/31.8; 347/20

(57) ABSTRACT

An ink for inkjet recording includes a colorant; an organic solvent; a surfactant; and water. The organic solvent includes a polyol having a solubility parameter (SP value) of from 11.8 to 14.0 (components A) or an oxetane compound having the following formula (I) (components B):

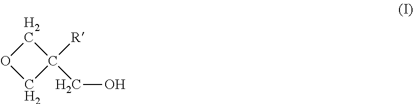

wherein R′ represents an alkyl group having 1 to 2 carbon atoms.

The content of at least one member of the components A or the components B is from 30 to 70% by weight per 100% by weight of the ink.

The colorant is a hydrodispersible pigment having a functional group selected from the group consisting of —COOM, —SO₃M, —PO₃HM, —PO₃M₂, —CONM₂, —SO₃NM₂, —NH—C₆H₄—COOM, —NH—C₆H₄—SO₃M, —NH—C₆H₄—PO₃HM, —NH—C₆H₄—PO₃M₂, —NH—C₆H₄—CONM₂ and —NH—C₆H₄—SO₃NM₂, wherein M is a quaternary ammonium ion.

### CROSS-REFERENCE TO RELATED APPLICATIONS

This patent application is based on and claims priority pursuant to 35 U.S.C. §119 to Japanese Patent Applications Nos. 2013-190222 and 2014-151420, filed on Sep. 13, 2013 and Jul. 25, 2014, respectively in the Japan Patent Office, the entire disclosure of which is hereby incorporated by reference herein.

### BACKGROUND

1. Technical Field

The present invention relates to an ink for inkjet recording, an image forming method, an image forming apparatus and an image formed material.

2. Description of the Related Art

An aqueous pigment inkjet ink has less bleeding, high image density and less coming out from the back when printed on a plain paper.

However, when a picture or a drawing needing much ink when printed on a plain paper is printed thereon, the plain paper is likely to curl back (the paper warps toward the opposite side of a printed side) right after printed.

When the plain paper curls back right after printed, papers are not smoothly fed in an inkjet printer. Particularly when a paper curls back in high-speed printing or both side printing, the paper is very difficult to feed.

Therefore, an inkjet ink causing a paper to curl back less even when printing a picture or a drawing needing much ink is demanded.

Particularly, a high-speed inkjet printer including a line head needs such an ink more than a serial printer.

As conventional methods of preventing the curl, Japanese published unexamined application No. JP-2011-236423-A discloses using a solid moisturizer as a curl inhibitor, Japanese published unexamined application No. JP-2012-036389-A discloses using polyoxyethylene glyceryl ether, Japanese published unexamined application No. JP-2012-107210-A discloses using a hydrophobic solvent alkoxy amide derivative, and Japanese published unexamined application No. JP-2012-179761-A discloses using polytungstate in a curl inhibiting liquid.

Further, Japanese published unexamined applications Nos. JP-2009-019198-A and JP-2010-084116-A disclose adding polyol in not less than a specific amount to prevent deterioration of dischargeability as an adverse effect of an ink inhibiting the curl.

### SUMMARY

Accordingly, one object of the present invention is to provide an ink for inkjet recording, capable of reducing curl after printing, stabilizing discharge from head nozzle, preventing ink anchorage in retainer, and having good storage stability.

Another object of the present invention is to provide an image forming method using the ink.

A further object of the present invention is to provide an image forming apparatus using the ink.

Another object of the present invention is to provide an image formed material using the ink.

These objects and other objects of the present invention, either individually or collectively, have been satisfied by the discovery of an ink for inkjet recording, including a colorant; an organic solvent; a surfactant; and water, wherein the organic solvent includes a polyol having a solubility parameter (SP value) of from 11.8 to 14.0 (components A) or an oxetane compound having the following formula (I) (components B):

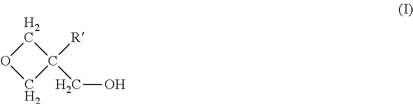

wherein R′ represents an alkyl group having 1 to 2 carbon atoms,

wherein the content of at least one member of the components A or the components B is from 30 to 70% by weight per 100% by weight of the ink, and

wherein the colorant is a hydrodispersible pigment having a functional group selected from the group consisting of —COOM, —SO₃M, —PO₃HM, —PO₃M₂, —CONM₂, —SO₃NM₂, —NH—C₆H₄—COOM, —NH—C₆H₄—SO₃M, —NH—C₆H₄—PO₃HM, —NH—C₆H₄—PO₃M₂, —NH—C₆H₄—CONM₂ and —NH—C₆H₄—SO₃NM₂, wherein M is a quaternary ammonium ion.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a schematic view illustrating a serial type image forming apparatus which is an embodiment of the present invention;

FIG. 2 is a plane view illustrating a main part of the image forming apparatus in FIG. 1; and

FIG. 3 is a schematic view illustrating a line type image forming apparatus which is an embodiment of the present invention.

### DETAILED DESCRIPTION

The present invention provides an ink for inkjet recording, capable of reducing curl after printing, stabilizing discharge from head nozzle, preventing ink anchorage in retainer, and having good storage stability.

### [Solubility Parameter (SP Value)]

As it is known, a solubility parameter (SP value) is defined as a square root of a molecular cohesion energy. Specifically, the SP value is determined by the following formula (1):

Solubility Parameter δ=(ΔE/V)^{1/2} (1)

wherein ΔE is a cohesion energy (cal/mol), V is a mol volume (cm³/mol) and ΔE/V is a cohesion energy density (vaporization heat per unit volume).

Practically, the solubility parameter (SP value) is determined from a square root of evaporation heat needed to evaporate 1 cm³ liquid (cal/cm³)^{1/2}.

In the present invention, increasing a ratio of an organic solvent and using a solvent having low moisture retainability to quickly evaporate a moisture in the ink can reduce moisture causing back curl. Further, quickly aggregating a pigment and increasing viscosity thereof in the process of drying an ink after landing on a paper improves image quality on a plain paper. However, an ink the affinity with cellulose (paper base) of which is simply controlled to prevent curl may have adverse effects such as deterioration of discharge stability from head nozzle and storage stability. The present invention solves this problem as well.

Namely, since the solvent and the hydrodispersible colorant having a functional group particularly have good compatibility with each other in the ink, combination of a specific amount of the solvent and the hydrodispersible colorant having a functional group prevents increase of viscosity when a moisture evaporates to improve discharge reliability. Further, the ink anchorage in a printer is effectively prevented. In addition, the ink has quite good storage stability.

The hydrodispersible pigment includes a pigment dispersed in a surfactant, a pigment dispersed in a resin, a pigment covered with a resin and a pigment a hydrophilic group is formed on. An ink using a hydrodispersible pigment having a functional group selected from the group consisting of —COOM, —SO₃M, —PO₃HM, —PO₃M₂, —CONM₂, —SO₃NM₂, —NH—C₆H₄—COOM, —NH—C₆H₄—SO₃M, —NH—C₆H₄—PO₃HM, —NH—C₆H₄—PO₃M₂, —NH—C₆H₄—CONM₂ and —NH—C₆H₄—SO₃NM₂, wherein M is a quaternary ammonium ion, particularly has high storage stability and prevents increase of viscosity when a moisture is evaporated. It is thought this is because the quaternary ammonium ion stably keeps dispersion of the hydrodispersible pigment in the ink even when a moisture is evaporated therefrom and the content of the organic solvent becomes high as a result.

Further, an ink using the polyol or the oxetane compound having the following formula (I), which has a solubility parameter (SP value) of from 11.8 to 14.0 reduces cockling (a solid image waves) and curl after printing:

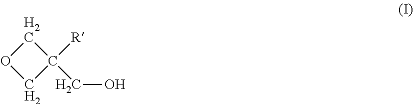

wherein R′ represents an alkyl group having 1 to 2 carbon atoms.

In addition, an ink having a dynamic surface tension not greater than 35 m n/m when a surface life is 1500 ms at 5° C. in maximum foaming pressure method well wets the surface of a paper to improve colorability and prevent white spots.

Hereinafter, the ink for inkjet recording, the image forming method, the image forming apparatus of the present invention, and the image formed material made by the image forming method are further explained in detail.

### <Ink for Inkjet Recording>

### —Organic Solvent—

The ink for inkjet recording of the present invention using polyol or an oxetane compound having the formula (I), which has a solubility parameter (SP value) of from 11.8 to 14.0 as an organic solvent can reduce back curl after printing.

Specific examples of the polyol having a solubility parameter (SP value) of from 11.8 to 14.0 include 3-methyl-1,3-butanediol (SP value: 12.05), 1,2-butanediol (SP value: 12.75), 1,3-butanediol (SP value: 12.75), 1,4-butanediol (SP value: 12.95), 2,3-butanediol (SP value: 12.55), 1,2-propanediol (SP value: 13.48), 1,3-propanediol (SP value: 13.72), 1,2-hexanediol (SP value: 11.80), 1,6-hexanediol (SP value: 11.95), 3-methyl-1,5-pentanediol (SP value: 11.80), triethylene glycol (SP value: 12.12) and diethylene glycol (SP value: 13.02).

Specific examples of the oxetane compound having the formula (I) include compounds having the following formulae (I′) and (I″):

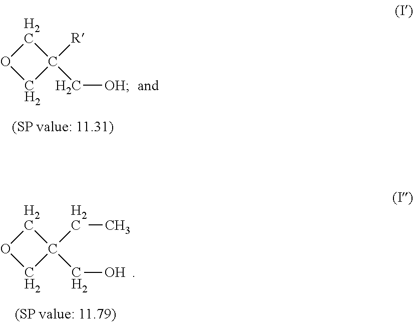

Particularly, 3-methyl-1,3-butanediol (SP value: 12.05), 1,2-butanediol (SP value: 12.75), 1,3-butanediol (SP value: 12.75), 1,4-butanediol (SP value: 12.95), 2,3-butanediol (SP value: 12.55), 1,2-propanediol (SP value: 13.48), 1,3-propanediol (SP value: 13.72) and 3-ethyl-3-hydroxymethyloxetane (SP value: 11.31) having the formula (I′) are preferably used.

The ink for inkjet preferably includes the polyol or the oxetane compound having the formula (I) alone, which has a solubility parameter (SP value) of from 11.8 to 14.0 in an amount of from 30 to 70% by weight, and more preferably from 40 to 60% by weight.

When less than 30% by weight, the curl is not effectively prevented. When greater than 70% by weight, image quality may deteriorate or the ink noticeably increases in viscosity, resulting in deterioration of discharge stability thereof.

The ink preferably includes at least one of a non-wettable polyol compound or a glycol ether compound having 8 to 11 carbon atoms as a penetrant. Non-wettability means a solubility of from 0.2% to 5.0% by weight in water at 25° C. As the penetrant, a 1,3-diol compound having the following formula (II) is preferable, and 2-ethyl-1,3-hexane diol (having solubility of 4.2% at 25° C.) and 2,2,4-trimethyl-1,3-pentane diol (having solubility of 2.0% at 25° C.) are particularly preferable:

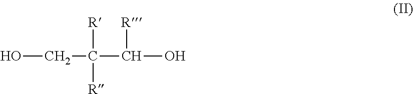

wherein R′ represents a methyl group or an ethyl group; R″ represents a hydrogen atom or a methyl group; and R′″ represents an ethyl group or a propyl group.

Specific examples of the other non-wettable polyol compounds include, but are not limited to, aliphatic diols such as 2-ethyl-2-methyl-1,3-propanediol, 3,3-dimethyl-1,2-butane diol, 2,2-diethyl-1,3-propane diol, 2-methyl-2-propyl-1,3-propane diol, 2,4-dimethyl-2,4-pentane diol, 2,5-dimethyl-2,5-hexane diol, and 5-hexene-1,2-diol.

The ink preferably includes the penetrant in an amount of from 0.5 to 5% by weight, and more preferably from 1 to 3% by weight to improve permeability thereof and image quality. In addition, the penetrant is well dissolved in the ink and not separated therefrom to improve viscosity thereof.

### —Hydrodispersible Colorant—

Next, the hydrodispersible colorant for use in the present invention is explained.

The hydrodispersible colorant having a hydrophilic group includes at least a hydrophilic functional group selected from the group consisting of —COOM, —SO₃M, —PO₃HM, —PO₃M₂, —CONM₂, —SO₃NM₂, —NH—C₆H₄—COOM, —NH—C₆H₄—SO₃M, —NH—C₆H₄—PO₃HM, —NH—C₆H₄—PO₃M₂, —NH—C₆H₄—CONM₂ and —NH—C₆H₄—SO₃NM₂ on the surface of a pigment, wherein M is a quaternary ammonium ion, which has hydrodispersibility even under no presence of dispersant. Typically, they are called “self-dispersible pigment”.

As for the pigment, an organic pigment, or an inorganic pigment can be used. The colorant may contain a dye in order to adjust a color tone, as long as it does not deteriorate weather resistance of a resulting ink.

Examples of the inorganic pigment include titanium oxide, iron oxide, calcium carbonate, barium sulfate, aluminum hydroxide, barium yellow, cadmium red, chrome yellow, and carbon black. Among them, the carbon black is particularly preferable. Examples of the carbon black include those produced by the conventional methods such as a contact method, furnace method and thermal method.

Examples of the colorant for black include: carbon blacks (C.I. Pigment Black 7) such as channel black, furnace black, gas black, and lamp black. Examples of the commercial products of the carbon black include carbon black obtained from Cabot Corporation under the trade names of Regal®, Black Pearls®, Elftex®, Monarch®, Mogul®, and Vulcan® such as Black Pearls® 2000, Black Pearls® 1400, Black Pearls® 1300, Black Pearls® 1100, Black Pearls® 1000, Black Pearls® 900, Black Pearls® 880, Black Pearls® 800, Black Pearls® 700, Black Pearls® 570, Black Pearls® L, Elftex® 8, Monarch® 1400, Monarch® 1300, Monarch® 1100, Monarch® 1000, Monarch® 900, Monarch® 880, Monarch® 800, Monarch® 700, Regal® 660, Mogul® L, Regal® 330, Regal® 400 and Vulcan® P; and SENSIJET Black SDP100 (SENSIJET), SENSIJET Black SDP1000 (SENSIJET), SENSIJET Black SDP2000 (SENSIJET), etc.

Examples of the organic pigment include an azo pigment, polycyclic pigment, dye chelate, nitro pigment, nitroso pigment, and aniline black. Among them, the azo pigment, and polycyclic pigment are more preferable. Examples of the azo pigment include azo lake, an insoluble azo pigment, a condensed azo pigment, and a chelate azo pigment. Examples of the polycyclic pigment include a phthalocyanine pigment, a perylene pigment, a perynone pigment, an anthraquinone pigment, a quinacridon pigment, a dioxazine pigment, an indigo pigment, a thioindigo pigment, an isoindolinone pigment, and a quinophthalone pigment. Examples of the dye chelate include a basic dye chelate, and an acidic dye chelate.

Specific examples of the organic pigment include C.I. Pigment Yellow 1, 3, 12, 13, 14, 17, 24, 34, 35, 37, 42 (yellow iron oxide), 53, 55, 74, 81, 83, 95, 97, 98, 100, 101, 104, 108, 109, 110, 117, 120, 128, 138, 150, 151, 153, 155, 183, 213; C.I. Pigment Orange 5, 13, 16, 17, 36, 43, 51; C.I. Pigment Red 1, 2, 3, 5, 17, 22, 23, 31, 38, 48:2, 48:2 (Permanent Red 2B(Ca)), 48:3, 48:4, 49:1, 52:2, 53:1, 57:1 (Brilliant Carmine 6B), 60:1, 63:1, 63:2, 64:1, 81, 83, 88, 101 (colcothar), 104, 105, 106, 108 (Cadmium Red), 112, 114, 122 (quinacridon magenta), 123, 146, 149, 166, 168, 170, 172, 177, 178, 179, 185, 190, 193, 209, 219; C.I. Pigment Violet 1 (Rhodamine Lake), 3, 5:1, 16, 19, 23, 38; C.I. Pigment Blue 1, 2, 15 (phthalocyanine blue), 15:1, 15:2, 15:3 (phthalocyanine blue), 15:4 (phthalocyanine blue), 16, 17:1, 56, 60, 63; C.I. phthalocyanine Green 1, 4, 7, 8, 10, 17, 18, 36.

Further, the pigment may be oxidized with an oxidant to introduce an ionic group and an ionizable group on the surface thereof.

The surface-treated pigment is preferably ionizable and anionically charged.

Examples of the anionic functional group in the self-dispersible pigment include —COOM, —SO₃M, —PO₃HM, —PO₃M₂, —CONM₂, —SO₃NM₂, NH—C₆H₄—COOM, —NH—C₆H₄—SO₃M, —NH—C₆H₄—PO₃HM, —NH—C₆H₄—PO₃M₂, —NH—C₆H₄—CONM₂, and —NH—C₆H₄—SO₃NM₂, wherein M is quaternary ammonium.

Examples of the quaternary ammonium ion include tetramethyl ammonium ion, tetraethyl ammonium ion, tetrapropyl ammonium ion, tetrabutyl ammonium ion, tetrapentyl ammonium ion, benzyltrimethyl ammonium ion, benzyl triethyl ammonium ion, and tetrahexyl ammonium ion. Among them, tetraethyl ammonium ion, tetrabutyl ammonium ion, and benzyl trimethyl ammonium ion are preferably, and tetrabutyl ammonium ion is particularly preferable.

The anionic functional groups can be bonded to surfaces of pigment particles in accordance with the methods disclosed in Japanese Patent No. JP-4697757-B, Japanese published unexamined application No. JP-2003-513137-A, International Application Publication No. WO 97/48769, and Japanese published unexamined applications Nos. JP-10-110129-A, JP-H11-246807-A, JP-H11-57458-A, JP-H11-189739-A, JP-H11-323232-A, and JP-2000-265094-A.

Use of the hydrodispersible pigment having the anionic functional group and quaternary ammonium ion enables to maintain the stable dispersion state of the hydrodispersible pigment either in a water-rich ink, or in an organic solvent-rich ink from which the moisture has been evaporated, as the anionic functional group and quaternary ammonium ion exhibits affinity.

The pigment preferably has a BET surface area of from 10 to 1500 m²/g, more preferably from 20 to 600 m²/g, and most preferably from 50 to 300 m²/g.

The pigment may be typically pulverized by a ball mill, a jet mill or an ultrasonic wave to have a desired particle diameter.

The hydrodispersible colorant preferably has a volume-average particle diameter (D50) of from 10 to 200 nm in an ink.

The ink for inkjet recording preferably includes the hydrodispersible colorant in an amount of from 1 to 15% by weight, and more preferably from 2 to 10% by weight as a solid content.

### —Hydrodispersible Resin—

The ink of the present invention may include a hydrodispersible resin such as condensation-based resins, addition-based resins, and natural polymers. The hydrodispersible resins have excellent film-forming (image forming) property, water repellency, water-resistance, and weathering properties. Therefore, these are suitable for image recording requiring high water-resistance and high image density. The hydrodispersible resin is preferably used as a particulate resin.

Specific examples of the condensation-based resins include, but are not limited to, polyester resins, polyurethane resins, polyepoxy resins, polyamide resins, polyether resins, poly(meth)acrylic resins, acrylic-silicone resins, and fluorine-containing resins.

Specific examples of the addition-based resins include, but are not limited to, polyolefin resins, polystyrene resins, polyvinyl alcohol resins, polyvinyl ester resins, polyacrylic acid resins, and unsaturated carboxylic acid resins.

Specific examples of the natural resins include, but are not limited to, celluloses, rosins, and natural rubber.

Among these, polyurethane resin particulates, acrylic-silicone resin particulates, and fluorine-containing resin particulates are preferable. These can be used alone or in combination.

As the fluorine-containing resins, fluorine-containing resin particulates having fluoro-olefin units are preferable. Among these, fluorine-containing vinyl ether resin particulates formed of fluoro-olefin units and vinyl ether units are particularly preferable.

There is no specific limit to the selection of the fluoro-olefin units. Specific examples thereof include, but are not limited to, —CF₂CF₂—, —CF₂CF(CF₃)—, and —CF₂CFCl—.

There is no specific limit to the selection of fluoro-olefin units. For example, the compounds having the following formulae in Table 1.

TABLE 1

| | |
|---|---|
| 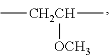 | 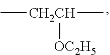 |
| 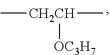 | 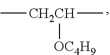 |
| 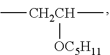 | 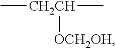 |
| 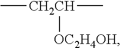 | 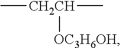 |
| 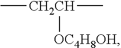 | 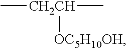 |
| 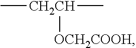 | 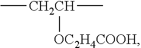 |
| 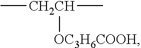 | 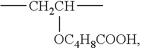 |
| 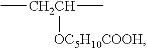 | 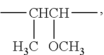 |
| 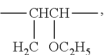 | 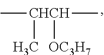 |
| 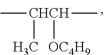 | 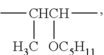 |
| 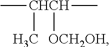 | 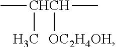 |
| 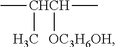 | 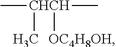 |
| 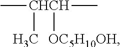 | 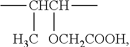 |
| 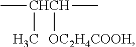 | 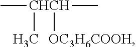 |
| 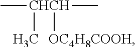 | 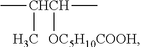 |

As the fluorine-containing vinyl ether resin particulates formed of fluoro-olefin units and vinyl ether units, alternate copolymers in which fluoro-olefin units and vinyl ether units are alternately co-polymerized are preferable.

Any suitably synthesized fluorine-containing resin particulates and products thereof available in the market can be also used. Specific examples of the products available in the market include, but are not limited to, FLUONATE FEM-500, FEM-600, DICGUARD F-52S, F-90, F-90M, F-90N, and AQUA FURAN TE-5A (all from DIC Corporation); and LUMIFLON FE4300, FE4500, and FE4400, ASAHI GUARD AG-7105, AG-950, AG-7600, AG-7000, and AG-1100 (all from ASAHI GLASS CO., LTD.).

The hydrodispersible resins can be used as homopolymers or complex resins as copolymers. Any of single phase structure type, core-shell type, and power feed type emulsions is suitable.

A hydrodispersible resin that has a hydrophilic group with self dispersibility or no dispersibility while dispersibility is imparted to a surfactant or a resin having hydrophilic group can be used as the hydrodispersible resin. Among these, emulsions of resin particles obtained by emulsification polymerization or suspension polymerization of ionomers or unsaturated monomers of a polyester resin or polyurethane resin are most suitable. In the case of emulsification polymerization of an unsaturated monomer, since a resin emulsion is obtained by reaction in water to which an unsaturated monomer, a polymerization initiator, a surfactant, a chain transfer agent, a chelate agent, pH adjusting agent, etc. are added, it is easy to obtain a hydrodispersible resin and change the resin components. Therefore, a hydrodispersible resin having target properties is easily obtained.

The volume-average particle diameter (D50) of the hydrodispersible resin is related to the viscosity of the liquid dispersion. If the composition is the same, the viscosity at the same solid portion increases as the particle diameter decreases. To avoid preparing ink having an excessively high viscosity, the volume-average particle diameter (D50) of the hydrodispersible resin is preferably 50 nm or more. In addition, particles having a larger particle diameter than the size of the nozzle mouth of the inkjet head are not usable. When large particles smaller than the nozzle mouth are present in the ink, the discharging property of the ink deteriorates. The volume-average particle diameter (D50) of the hydrodispersible resin is preferably 200 nm or less and more preferably 150 nm or less in order not to degrade the discharging property.

In addition, preferably the hydrodispersible resin has a feature of fixing the hydrodispersible coloring agent on a recording medium (typically, paper) and forms a film at room temperature to improve the fixing property of the coloring material. Therefore, the minimum film-forming temperature (MFT) of the hydrodispersible resin is preferably 30° C. or lower. In addition, when the glass transition temperature of the hydrodispersible resin is too low (e.g., −40° C. or lower), the viscosity of the resin film tends to increase, thereby causing the obtained image sheet to increase tackiness. Therefore, the glass transition temperature of the hydrodispersible resin is preferably −30° C. or higher.

The ink preferably includes the hydrodispersible resin in an amount of from 0.5 to 10% by weight, and more preferably from 1 to 8% in a solid form.

### —Surfactant—

The surfactant preferably does not impair dispersion stability due to combination of the hydrodispersible colorant and the hydrosoluble organic solvent, has low static surface tension, and has high penetrating and leveling capability. A surfactant selected from the group consisting of anionic surfactants, nonionic surfactants, silicone surfactants and fluorine surfactants. Among these, the silicone surfactants, the fluorine surfactants and acetylene glycol or acetylene alcohol surfactants are particularly preferable.

These surfactants can be used alone or in combination.

The fluorine surfactants in which the number of carbon atoms replaced with fluorine atoms is from 2 to 16 is preferable and, 4 to 16, more preferable. When the number of carbon atoms substituted with fluorine is less than 2, an effect of fluorine may not be exhibited. When the number thereof is greater than 16, a problem may be caused in storage stability of the ink.

Examples of the nonionic fluorine-based surfactant include a perfluoroalkyl phosphate compound, a perfluoroalkyl ethylene oxide adduct, and a polyoxyalkylene ether polymer compound containing a perfluoroalkyl ether group at a side chain thereof. Among them, a polyoxyalkylene ether polymer compound containing a perfluoroalkyl ether group at a side chain thereof is preferable, as it is less foamable. A fluorine-based surfactant having the following formula (2) or (3) is more preferable:

CF₃CF₂(CF₂CF₂)ₘ—CH₂CH₂O(CH₂CH₂O)ₙH (2)

wherein m is preferably an integer of 0 to 10 and n is preferably an integer of 0 to 40 in order to impart water solubility.

CₙF₂ₙ₊₁—CH₂CH(OH)CH₂—O—(CH₂CH₂O)ₐ—Y′ (3)

wherein n is an integer of 2 to 6, a is an integer of 15 to 50, and Y′ is —C_{b}H_{2b+1} (b is an integer of 11 to 19), or —CH₂CH(OH)CH₂—C_{d}F_{2d+1} (d is an integer of 2 to 6).

Preferable examples of the compound having the formula (3) include compounds having the following formulae (a) to (v) in Table 2, as these have a high ability to reduce surface tension, and gives high permeability.

TABLE 2

(a) C₄F₉—CH₂CH(OH)CH₂O—(CH₂CH₂O)₂₁—C₁₂H₂₅
(b) C₄F₉—CH₂CH(OH)CH₂O—(CH₂CH₂O)₂₅—C₁₂H₂₅
(c) C₄F₉—CH₂CH(OH)CH₂O—(CH₂CH₂O)₃₀—C₁₂H₂₅
(d) C₄F₉—CH₂CH(OH)CH₂O—(CH₂CH₂O)₂₀—C₁₄H₂₉
(e) C₄F₉—CH₂CH(OH)CH₂O—(CH₂CH₂O)₃₀—C₁₄H₂₉
(f) C₄F₉—CH₂CH(OH)CH₂O—(CH₂CH₂O)₂₀—C₁₆H₃₃
(g) C₄F₉—CH₂CH(OH)CH₂O—(CH₂CH₂O)₂₃—C₁₆H₃₃
(h) C₄F₉—CH₂CH(OH)CH₂O—(CH₂CH₂O)₂₅—C₁₆H₃₃
(i) C₄F₉—CH₂CH(OH)CH₂O—(CH₂CH₂O)₃₀—C₁₆H₃₃
(j) C₄F₉—CH₂CH(OH)CH₂O—(CH₂CH₂O)₄₀—C₁₆H₃₃
(k) C₄F₉—CH₂CH(OH)CH₂O—(CH₂CH₂O)₂₀—C₁₈H₃₇
(l) C₄F₉—CH₂CH(OH)CH₂O—(CH₂CH₂O)₃₀—C₁₈H₃₇
(m) C₄F₉—CH₂CH(OH)CH₂O—(CH₂CH₂O)₄₀—C₁₈H₃₇
(n) C₄F₉—CH₂CH(OH)CH₂O—(CH₂CH₂O)₂₃—CH₂CH(OH)CH₂—C₄F₉
(o) C₄F₉—CH₂CH(OH)CH₂O—(CH₂CH₂O)₃₅—CH₂CH(OH)CH₂—C₄F₉
(p) C₄F₉—CH₂CH(OH)CH₂O—(CH₂CH₂O)₄₅—CH₂CH(OH)CH₂—C₄F₉
(q) C₆F₁₃—CH₂CH(OH)CH₂O—(CH₂CH₂O)₂₁—C₁₂H₂₅
(r) C₆F₁₃—CH₂CH(OH)CH₂O—(CH₂CH₂O)₂₅—C₁₂H₂₅
(s) C₆F₁₃—CH₂CH(OH)CH₂O—(CH₂CH₂O)₃₀—C₁₂H₂₅
(t) C₆F₁₃—CH₂CH(OH)CH₂O—(CH₂CH₂O)₂₃—-CH₂CH(OH)CH₂—C₆F₁₃
(u) C₆F₁₃—CH₂CH(OH)CH₂O—(CH₂CH₂O)₃₅—CH₂CH(OH)CH₂—-C₆F₁₃
(v) C₆F₁₃—CH₂CH(OH)CH₂O—(CH₂CH₂O)₄₅—CH₂CH(OH)CH₂—C₆F₁₃

Among them, the compounds represented by the formula (a) to (c), and (n) to (v) are particularly preferable, as they have excellent compatibility to the organic solvent.

As for the fluorine-based surfactant, a commercial product may be used. Examples of the commercial product thereof include: SURFLON S-111, S-112, S-113, S-121, S-131, S-132, S-141, S-145 (all from ASAHI GLASS CO., LTD.); FLUORAD FC-93, FC-95, FC-98, FC-129, FC-135, FC-170C, FC-430, FC-431 (all from Sumitomo 3M Limited); MEGAFACE F-470, F-1405, F-474 (all from DIC Corporation); Zonyl TBS, FSP, FSA, FSN-100, FSN, FSO-100, FSO, FS-300, UR (all from Du Pont Kabushiki Kaisha); FT-110, FT-250, FT-251, FT-400S, FT-150, FT-400SW (all from NEOS COMPANY LIMITED); PolyFox PF-136A, PF-156A, PF-151N, PF-154, PF-159 (all from Omnova Solutions, Inc.); and UNIDYNE DSN-403N (from DAIKIN INDUSTRIES, LTD.). Among them, particularly preferred are FS-300 from Du Pont Kabushiki Kaisha, FT-110, FT-250, FT-251, FT-400S, FT-150, and FT-400SW from NEOS COMPANY LIMITED, PolyFox PF-151N from Omnova Solutions, Inc., and UNIDYNE DSN-403N from DAIKIN INDUSTRIES, LTD., in view of excellent print quality, and wettability.

The silicone-based surfactant is appropriately selected depending on the intended purpose without any limitation, and examples thereof include side chain-modified polydimethylsiloxane, both terminal-modified polydimethylsiloxane, one terminal-modified polydimethylsiloxane, and side chain and both terminals-modified polydimethylsiloxane. Among them, particularly preferred is a polyether-modified silicone-based surfactant containing a polyoxyethylene group and polyoxyethylene polyoxypropylene group as a modified group, as it has excellent properties as an aqueous surfactant.

The silicone-based surfactant is not particularly limited, and may be appropriately synthesized for use, or selected from commercial products. The commercial products thereof are readily available, for example, from BYK Japan K.K., Shin-Etsu Chemical Co., Ltd., Dow Corning Toray Co., Ltd., Nihon Emulsion Co., Ltd., and KYOEISHA CHEMICAL CO., LTD.

The polyether-modified silicone-based surfactant is appropriately selected depending on the intended purpose without any limitation, and examples thereof include a compound, in which a polyalkylene oxide structure having the following formula (4) is introduced into a Si site of the side chain of dimethyl polysiloxane.

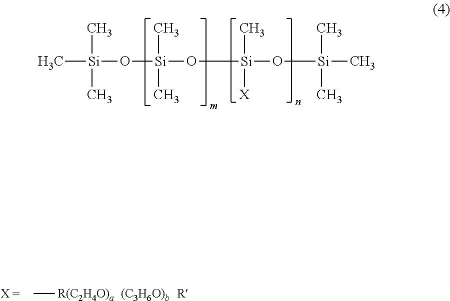

wherein m, n, a, and b are each an integer; and R and R′ are each an alkyl group or an alkylene group.

The polyether-modified silicone-based surfactant is not particularly limited, and may be appropriately synthesized for use, or selected from commercial products. Examples of the commercial products thereof include: KF-618, KF-642, KF-643 (all from Shin-Etsu Chemical Co., Ltd.); EMALEX-SS-5602, SS-1906EX (all from Nihon Emulsion Co., Ltd.); FZ-2105, FZ-2118, FZ-2154, FZ-2161, FZ-2162, FZ-2163, FZ-2164 (all from Dow Corning Toray Co., Ltd.); BYK-33, BYK-387 (both from BYK Japan KK); and TSF4440, TSF4452, and TSF4453 (all from Momentive Performance Materials Inc.).

The acetylene glycol-based surfactant, or the acetylene alcohol-based surfactant is preferably a compound having the following formula (5), (6), or (7):

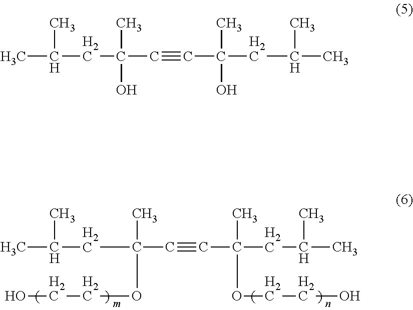

wherein m or n is an integer;

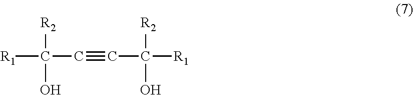

wherein R₁ and R₂ are each an alkyl group.

The acetylene glycol-based surfactant or acetylene alcohol-based surfactant is not particularly limited, and may be appropriately synthesized for use, or selected from commercial products. Examples of the commercial products thereof include: Dynol 604, Dynol 607 (both from Air Products and Chemicals Inc.); Surfynol 104, Surfynol 420, Surfynol 440, Surfynol SE (all from Nissin Chemical Industry Co., Ltd.); OLFINE E1004, OLFINE E1010, OLFINE EXP.4001, OLFINE EXP.4200, OLFINE EXP.4051F, OLFINE EXP.4123 (all from Nissin Chemical Industry Co., Ltd.).

Examples of the anionic surfactant include an acetic acid salt of polyoxyethylene alkyl ether, dodecyl benzene sulfonic acid salt, lauric acid salt, and polyoxyethylene alkyl ether sulfate salt.

Examples of the nonionic surfactant include polyoxyethylene alkyl ether, polyoxypropylene polyoxyethylene alkyl ether, polyoxyethylene alkyl ester, polyoxyethylene sorbitan fatty acid ester, polyoxyethylene alkyl phenyl ether, polyoxyethylene alkyl amine, and polyoxyethylene alkyl amide.

An amount of the surfactant is appropriately selected depending on the intended purpose without any limitation, but the amount thereof is preferably 0.001 to 5% by weight, more preferably 0.05 to 1% by weight, relative to a total amount of the recording ink. When the amount thereof is in the range of 0.001 to 5% by weight, an excellent effect obtainable by adding a surfactant is exhibited.

### —Other Components—

The aforementioned other components are appropriately selected depending on the intended purpose without any limitation, and examples thereof include a foam inhibitor (defoaming agent), a pH regulator, an antiseptic-antifungal agent, a chelating reagent, an anti-rust agent, an antioxidant, an ultraviolet absorber, an oxygen absorber, and a photostabilizer.

### <Foam Inhibitor>

The foam inhibitor may be included in the ink of the present invention in a small amount to inhibit foams therein.

In the present invention, a compound having the following formula (8) is suitably used:

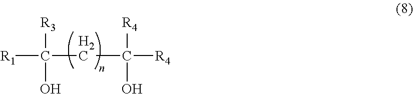

wherein R₁ and R₂ are each independently a C3-C6 alkyl group; R₃ and R₄ are each independently a C1-C2 alkyl group; and n is an integer of 1 to 6.

Examples of the compound represented by the general formula (8) include 2,4,7,9-tetramethyldecane-4,7-diol, and 2,5,8,11-tetramethyldodecane-5,8-diol. Among them, particularly preferred is 2,5,8,11-tetramethyldodecane-5,8-diol, as it has an effect of inhibiting foaming, and high compatibility to an ink.

An amount of the foam inhibitor in the recording ink is appropriately selected depending on the intended purpose without any limitation, but the amount thereof is preferably 0.01 to 10% by weight, more preferably 0.1 to 5% by weight. When the amount of the foam inhibitor in the range of 0.01 to 10% by weight, an excellent effect of inhibiting foaming can be attained.

### <pH Regulator>

The pH regulator is appropriately selected depending on the intended purpose without any limitation, provided that it does not adversely affect a recording ink to be prepared, and can adjust pH of the ink to the range of 7 to 11. Examples of the pH regulator include alcohol amine, hydroxide of an alkali metal element, hydroxide of ammonium, phosphonium hydroxide, and carbonate of alkali metal.

Examples of the alcohol amine include diethanol amine, triethanol amine, and 2-amino-2-ethyl-1,3-propanediol.

### <Antiseptic-Antifungal Agent>

Examples of the antiseptic-antifungal agent include sodium dehydroacetate, sodium sorbate, sodium 2-pyridinethiol-1-oxide, sodium benzoate, and sodium pentachlorophenol.

### <Chelating Reagent>

Examples of the chelating agent include sodium ethylenediamine tetraacetate, sodium nitrilotriacetate, sodium hydroxyethylethylenediamine triacetate, sodium diethylenetriamine pentaacetate, and sodium uramil diacetate.

### <Anti-Rust Agent>

Examples of the anti-rust agent include acid sulfite, sodium thiosulfate, thiodiglycolic acid ammonium, diisopropyl ammonium nitrate, pentaerythritol tetranitrate, and dicyclohexyl ammonium nitrate.

### <Antioxidant>

Examples of the antioxidant include a phenolic antioxidant (including hindered phenolic antioxidant), an amine antioxidant, a sulfuric antioxidant, and a phosphoric antioxidant.

### <Ultraviolet Absorber>

Examples of the ultraviolet absorber include a benzophenone ultraviolet absorber, a benzotriazole ultraviolet absorber, a salicylate ultraviolet absorber, a cyanoacrylate ultraviolet absorber, and a nickel complex salt ultraviolet absorber.

### —Method of Preparing Ink for Inkjet Recording—

The ink for inkjet recording of the present invention is prepared by dispersing or dissolving a hydrodispersible colorant, an organic solvent, a hydrodispersible resin, a surfactant, a penetrant and water, and optionally other components in an aqueous medium, and optionally stirring and mixing the mixture. The stirring and mixing can be performed, for example, by a sand mill, a homogenizer, a ball mill, a paint shaker, or an ultrasonic disperser, and the stirring and mixing can be performed by an agitator using a typical agitating blade, a magnetic stirrer, or a high-speed disperser.

The viscosity of the inkjet recording ink at 25° C. is appropriately selected depending on the intended purpose without any limitation, but the viscosity thereof is preferably 5 to 25 mPa·s. When the viscosity of the ink is 5 mPa·s or greater, an effect of improving print density and quality of printed characters can be attained. When the viscosity of the ink is 25 mPa·s or less, moreover, excellent ejection ability can be secured.

The viscosity can be measured at 25° C., for example, by means of a viscometer (RE-550L, from Toki Sangyo Co., Ltd.).

The ink preferably has a static surface tension of 30 mN/m or less, and more preferably 28 mN/m or less at 25° C. When 30 mN/m or less, the penetration improves and the cockling and curls decrease, and the ink dries well on plain papers.

The ink for inkjet recording may be used in a container such as an ink cartridge.

The ink can used in any printers such as a piezoelectric element type in which ink droplets are discharged by transforming a vibration plate forming the wall of the ink flowing route using a piezoelectric element as a pressure generating device to press the ink in the ink flowing route as described in JP-H2-51734-A; a thermal type in which bubbles are produced by heating ink in the ink flowing route with a heat element as described in JP-S61-59911-A; and an electrostatic type in which ink droplets are discharged by transforming a vibration plate by a force of electrostatic generated between the vibration plate and the electrode while the vibration plate and the electrode are provided facing each other as described in JP-H6-71882-A.

### <Recording Media>

Various recording media such as plain papers, glossy papers, special papers, clothes, films OHP sheets and general print papers can be used. These can be used alone or in combination.

The ink recorded material has high-quality images, no bleeding, good stability, and can preferably be used for various applications such as letters or images recorded materials.

### <Image Forming Method and Image Forming Apparatus>

The inkjet recording method of the present invention contains at least an inkjet step, and may further contain appropriately selected other steps according to the necessity such as stimulus generating step and controlling step.

The inkjet recording device of the present invention contains at least an inkjet unit, and may further contain a surface treatment unit, and appropriately selected other units according to the necessity such as a stimulus generating unit and a controlling unit.

The inkjet recording method of the present invention is suitably carried out by the inkjet recording device of the present invention, and the inkjet step is suitably carried out by the inkjet unit. Moreover, the aforementioned other steps are suitably carried out by the aforementioned other units.

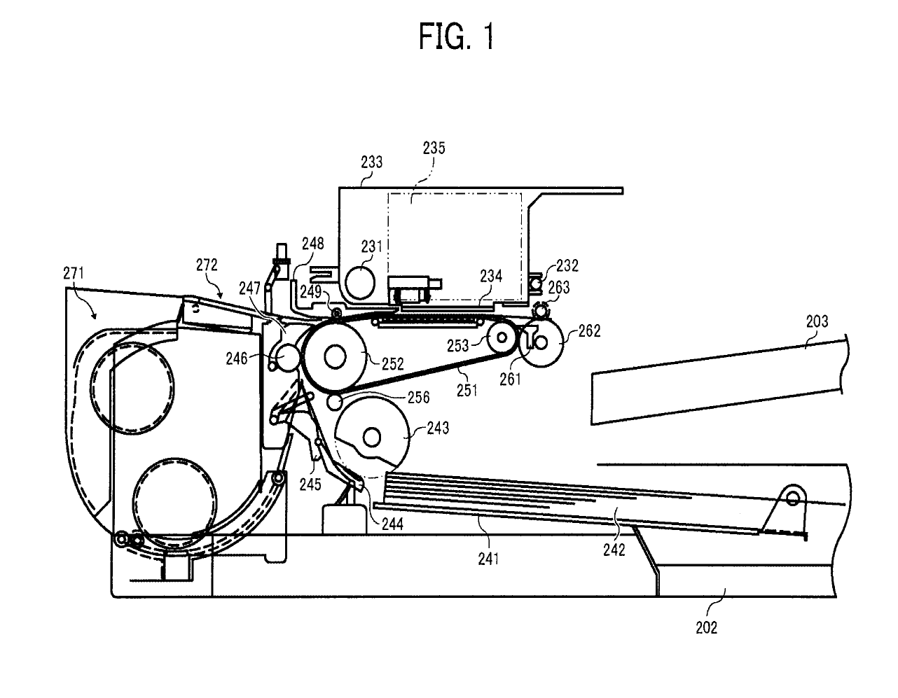

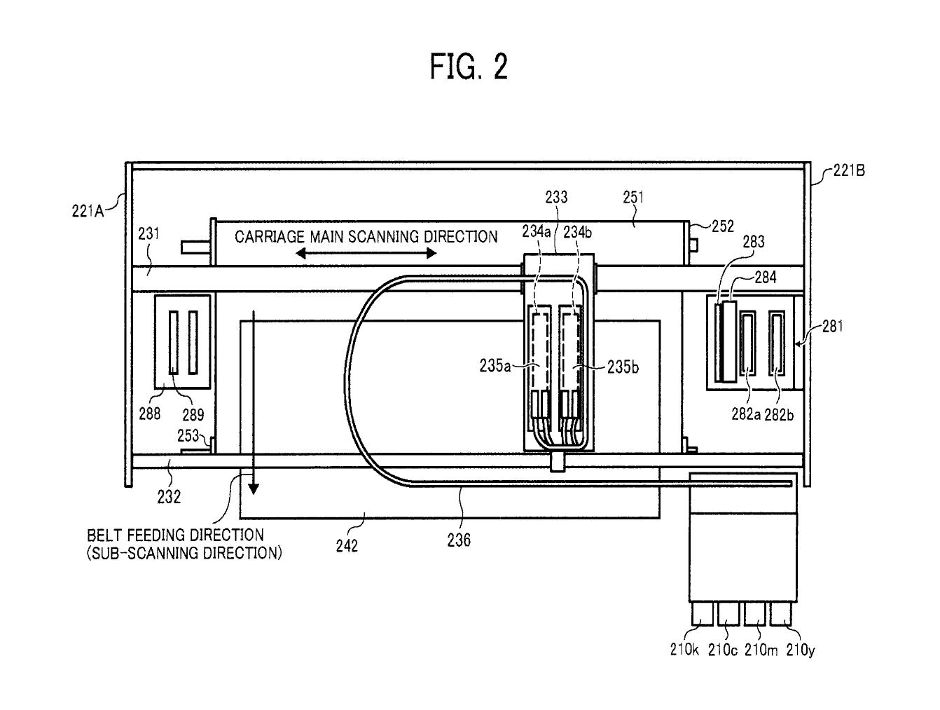

Hereinafter, a serial type image forming apparatus is explained, referring to FIGS. 1 and 2.

The serial type image forming apparatus therein slidably holds a carriage 233 with master/slave guide rods 231 and 232 horizontally hung over left/right side plates 201A and 201B, and moves the carriage 233 in an arrow direction (main scanning direction thereof) through a timing belt using main scanning motor.

The carriage 233 arranges nozzle lines formed of plural nozzles having recording heads 234a and 234b each formed of a liquid discharge head discharging an ink drop for each color yellow (Y), cyan (C), magenta (M) and black (K) in a sub-scanning direction perpendicular to the main scanning direction such that the ink discharges downward.

Each of the recording heads 234 has two nozzle lines, one nozzle line of the recoding head 234a discharges a black (K) droplet and the other nozzle line discharges a cyan (C) droplet. One nozzle line of the recoding head 234b discharges a magenta (M) droplet and the other nozzle line discharges a yellow (Y) droplet.

The carriage 233 is loaded with head tanks 235a and 235b supplying inks of each color parallel to the nozzle lines of the recording heads 234.

Each color ink is supplied to the head tank 235 through a supply tube for 236 from each color ink cartridge 210.

As a paper feeder feeding a paper 242 on a paper stacking unit (pressure plate) 241 of a paper feed tray 202, a semicircular roller (paper feed roller) 243 and a separation pad 244 formed of a material having a large friction coefficient separating and feeding the paper 242 one by one from the paper stacking unit 241 are equipped. The separation pad 244 is biased to the paper feed roller 243, facing thereto.

In order to feed the paper 242 fed from the paper feeder below the recording head 234, a guide member 245 guiding the paper 242, a counter roller 246, a feed guide member 247, a press member 248 having an edge pressure roller 249, and a feed belt 251 electrostatically adsorbing the paper 242 to feed the paper to a position opposite to the recording heads 234 are equipped.

The feed belt 251 is an endless belt hung between a feed roller 252 and a tension roller 253, rotating in a belt feeding direction (sub-scanning direction).

In addition, a charging roller 256 charging the surface of the feed belt 251 is equipped.

The charging roller 256 contacts the surface of the feed belt 251 and is driven to rotate in company with rotation of the feed belt 251. The feed belt 251 rotates in the belt feed direction as the feed roller 252 is driven to rotate by an unillustrated sub-scanning motor through timing.

As a paper discharger discharging the paper 242 recorded by the recording head 234, a separation claw 261 separating the paper 242 from the feed belt 251 and paper discharge rollers 262 and 263 are equipped. A paper discharge tray 203 is equipped below the paper discharge roller 262.

Further, the back of the apparatus is detachably equipped with a duplex unit 271.

The duplex unit 271 reverses a paper 242 returned by reverse rotation of the feed belt 251 and feed the paper 242 between the counter roller 246 and the feed belt 251. A manual tray 272 is located above the duplex unit 271.

In a non-printing area which is the other side of the scanning direction of the carriage 233, an ink collection unit (blank discharge receiver) 288 receiving a droplet when black discharge discharging a droplet which is not used for recording to discharge a recording liquid having increased in viscosity while recording is made is located. The ink collection unit (blank discharge receiver) 288 is equipped with an opening 289 along the nozzle line direction of the recording head 234.

In the image forming apparatus, the papers 242 are separately fed from the paper feed tray 202 one by one, the paper 242 fed upward almost vertically is guided by the guide 245 and fed between the feed belt 251 and the counter roller 246. The edge of the paper is guided by the feed guide 237 and pressed to the feed belt 251 by the edge pressure roller 249, and the feed direction is converted at almost 90°.

Then, a positive output and a negative output are alternately applied to the charging roller 256, i.e., an alternating voltage is applied thereto such that the feed belt 251 is charged in an alternating voltage pattern, i.e., the feed belt 251 is positively and negatively charged alternately in the shape of a band having a specific width. When a paper 242 is fed on the feed belt 251 positively and negatively charged alternately, the paper 242 is adsorbed to the feed belt 251 and fed in the sub-scanning direction by the rotation of the feed belt 251.

The recording head 234 is driven according to an image signal while the carriage 233 is moved to discharge an ink drop on a stopping paper 242 and record a line, and another line after the paper 242 is moved for a specific distance. When a record finishing signal or a signal indicating the end edge of a paper 242 reaches the recording area, recording operation is finished and the paper 242 is discharged on the paper discharge tray 203.

The serial type image forming apparatus equipped with the liquid discharger of the present invention stably discharge droplets for long periods and forms high-quality images.

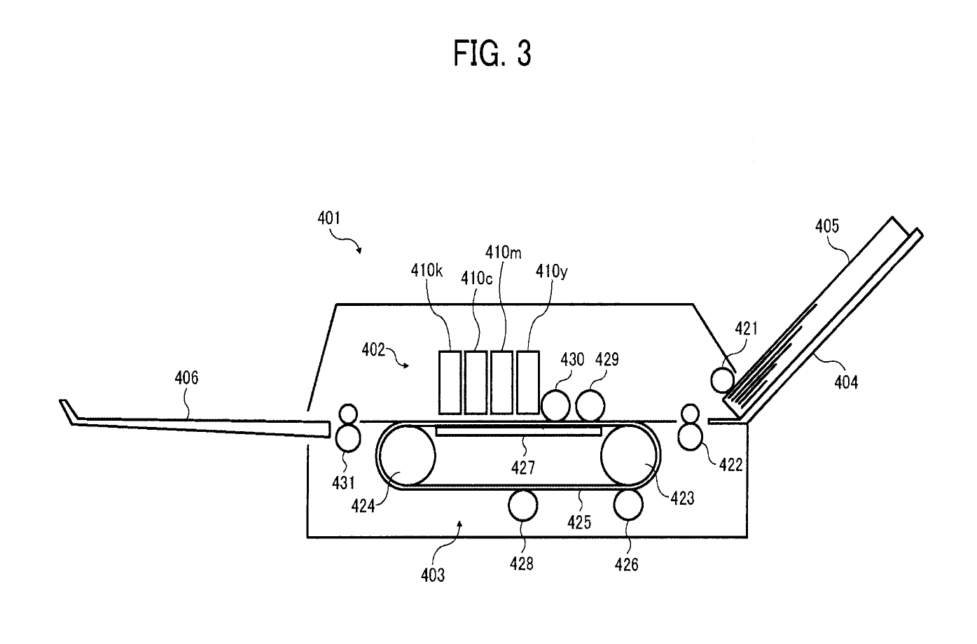

Next, a line type image forming apparatus is explained, referring to FIG. 3.

This line type image forming apparatus is equipped with a full-line head. An apparatus 401 includes an image former 402 and a sub-canning feeder 403 feeding papers. The apparatus is equipped with a paper feed tray 404 capable of loading multiple papers 405 on a side, and takes in a paper 405 fed from the paper feed tray 404. After an image is recorded on the paper 405 while fed by the sub-canning feeder 403, the paper 405 is discharged on a paper discharge tray 406 mounted on the other side of the apparatus 401.

The image former 402 includes a liquid tank containing a recording liquid, and is equipped with line heads 410y, 410m, 410c and 410k each formed of a liquid discharge head having a nozzle line equivalent to a length of the paper width direction (perpendicular to the feed direction).

These line heads 410y, 410m, 410c and 410k are attached to an unillustrated head holder.

The line heads 410y, 410m, 410c and 410k discharge yellow, magenta, cyan and black color droplets in this order, respectively from an upstream side of the paper feed direction.

The line head may be one head in which plural nozzle lines discharging each color are located at a predetermined interval or separated from a liquid cartridge.

The papers 405 in the paper feed tray 404 are separated and fed by a paper feed roller 421 one by one into the apparatus 401, and fed to the feeder 403 by a paper feed roller 422.

The feeder 403 includes a feed belt 425 hung between a drive roller 423 and a driven roller 424, a charging roller 426 charging the feed belt 425, a guide member (platen plate) 427 guiding the feed belt 425 at a position facing the image former 402, a recording liquid wiping member (cleaning roller) 428 formed of a porous material, which is a cleaner removing a recording liquid (ink) adhering to the feed belt 425, a discharge roller 429 mainly formed of an electroconductive rubber discharging a paper 405 and a paper press roller 430 pressing a paper 405 to the feed belt 425.

A paper discharge roller 431 feeding a paper 405 an image is recorded on to the paper discharge tray 406 is located at a downstream side of the feeder 403.

In the line type image forming apparatus, the feed belt 425 is charged to adsorb a paper 405, which is fed by the rotation of the feed belt 425, an image is formed thereon by the image former 402, and the paper is discharged on the paper discharge tray 406.

The line type image forming apparatus equipped with the liquid discharger of the present invention stably discharge droplets for long periods and forms high-quality images.

### —Ink Jetting Step (Example of Image Forming Process)—

The ink jetting step in the image forming method of the present invention is applying a stimulus (energy) to an ink to jet the ink onto the recording medium, onto which the pretreatment liquid has been applied, so as to form an image on the recording medium. As the method for applying stimulus (energy) to an ink so as to form an image on a recording medium various inkjet recording methods known in the art can be used. Examples of such inkjet recording method include an inkjet recording method of head-scanning system, and an inkjet recording method in which an image is recorded on a certain sheet-shaped recording medium using aligned heads.

In the ink jetting step, the driving system of a recording head, which is a unit for jetting the ink, is not particularly restricted. Examples of the driving system include a system using a piezoelectric element actuator using lead zirconate titanate (PZT); a system for functioning thermal energy; a system for using an on-demand head utilizing actuator or the like using electrostatic force; and a system in which a charge-controlling continuous jetting head is used for recording.

In the image forming method of the present invention, a heating and drying step may be made to recoding media an ink is jetted to when necessary. In this case, print papers can be dried by an infrared dryer, a microwave drier, a roll heater, drum heater, or hot air. Further, as a method of smoothing the surface of an image and fixing the image, a heat fixing step may be made to fix the image with a heat at 100 to 150° C. The fixing step improves glossiness and fixability of recorded images. As a heater, a roll heater or a drum heater, etc. having a heated mirror surface is preferably used. The mirror (smooth) surface of the roll heater or the drum heater can contact the surface of an image. A fixing roller heated to have a temperature of from 100 to 150° C. is preferably used in consideration of image quality, safety and economic efficiency.

### EXAMPLES

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### Examples 1 to 14 and Comparative Examples 1 to 10

### Preparation of Ink for Inkjet Recording

### Preparation Example 1

### Preparation of Surface-Modified Black Pigment Dispersion I

By means of Silverson Mixer (6,000 rpm), 100 g of Black Pearls (registered trade mark) 1000 (carbon black having a BET specific surface area of 343 m²/g and DBPA of 105 mL/100 g) from Cabot Corporation, 100 mmol of sulfanilic acid, and 1 L of ion-exchanged ultrapure water were mixed at room temperature. In the case where the pH of the obtained slurry was higher than 4, 100 mmol of nitric acid was added to the slurry. Thirty minutes later, sodium nitrite (100 mmol) dissolved in a small amount of ion-exchanged ultrapure water was gradually added to the aforementioned mixture. The resulting mixture was heated to 60° C. with stirring, and was allowed to react for 1 hour, to thereby generate a modified pigment, in which the sulfanilic acid was added to the carbon black. Subsequently, pH of the resultant was adjusted to 9 with a 10% tetrabutylammonium hydroxide (methanol) solution. Thirty minutes later, a modified pigment dispersion was obtained. Ultrafiltration with a permeable membrane was performed using the dispersion containing the pigment to which a sulfanilic acid group, or a sulfanilic acid tetrabutylammonium salt, or both were bonded, and ion-exchanged ultrapure water, and the resultant was further subjected to ultrasonic dispersion, to thereby obtain a modified pigment dispersion the pigment solid content of which had been concentrated to 20% by weight. The degree of the surface treatment was 0.75 mmol/g, and the volume-average particle diameter (D50) as measured by a particle size distribution measuring device (NANOTRACK UPA-EX150 from Nikkiso Co., Ltd.) was 120 nm.

### Preparation Example 2

### Preparation of Surface Modified Black Pigment Dispersion II

Into Process All 4HV Mixer (4 L), 500 g of Black Pearls (registered trade mark) 880 (carbon black having a BET surface area of 220 m²/g and DBPA of 105 mL/100 g) from Cabot Corporation, 1 L of ion-exchanged ultrapure water, and 175 mmol of 4-aminobenzoic acid. Subsequently, the resulting mixture was strongly mixed at 300 rpm, for 10 minutes with heating to 60° C. To the resultant, a 20% sodium nitrite aqueous solution [175 mmol equivalent based on the 4-aminobenzoic acid] was added over 15 minutes. The resulting mixture was mixed and stirred for 3 hours with heating to 60° C. The resulting reaction product was taken out by diluting with 750 mL of ion-exchanged ultrapure water. Subsequently, pH of the resultant was adjusted to 9 with a 10% tetrabutylammonium hydroxide (methanol) solution. Thirty minutes later, a modified pigment dispersion was obtained. Ultrafiltration with a permeable membrane was performed using the dispersion containing the pigment to which an amino benzoic acid group, or an amino benzoic acid tetrabutylammonium salt, or both were bonded, and ion-exchanged ultrapure water, and the resultant was further subjected to ultrasonic dispersion, to thereby obtain a modified pigment dispersion the pigment solid content of which had been concentrated to 20% by weight. The degree of the surface treatment was 0.5 mmol/g, and the volume-average particle diameter (D50) as measured by a particle size distribution measuring device (NANOTRACK UPA-EX150 from Nikkiso Co., Ltd.) was 104 nm.

### Preparation Example 3

### Preparation of Surface Modified Black Pigment Dispersion III

Into Process All 4HV Mixer (4 L), 500 g of Black Pearls (registered trade mark) 880 (carbon black having a BET surface area of 220 m²/g and DBPA of 105 mL/100 g) from Cabot Corporation, 1 L of ion-exchanged ultrapure water, and 175 mmol of 4-aminobenzoic acid. Subsequently, the resulting mixture was strongly mixed at 300 rpm, for 10 minutes with heating to 60° C. To the resultant, a 20% sodium nitrite aqueous solution [175 mmol equivalent based on the 4-aminobenzoic acid] was added over 15 minutes. The resulting mixture was mixed and stirred for 3 hours with heating to 60° C. The resulting reaction product was taken out by diluting with 750 mL of ion-exchanged ultrapure water. Subsequently, pH of the resultant was adjusted to 9 with a 10% tetraethylammonium hydroxide (methanol) solution. Thirty minutes later, a modified pigment dispersion was obtained. Ultrafiltration with a permeable membrane was performed using the dispersion containing the pigment to which an amino benzoic acid group, or an amino benzoic acid tetraethylammonium salt, or both were bonded, and ion-exchanged ultrapure water, and the resultant was further subjected to ultrasonic dispersion, to thereby obtain a modified pigment dispersion the pigment solid content of which had been concentrated to 20% by weight. The degree of the surface treatment was 0.35 mmol/g, and the volume-average particle diameter (D50) as measured by a particle size distribution measuring device (NANOTRACK UPA-EX150 from Nikkiso Co., Ltd.) was 114 nm.

### Preparation Example 4

### Preparation of Surface Modified Black Pigment Dispersion IV

One (1) kg of a self-dispersible carbon black Aqua-Black 162 pigment (pigment solid content 19.2% from Tokai Carbon Co., Ltd.) was subjected to acid deposition with a 0.1 NHCl aqueous solution. Subsequently, pH of the resultant was adjusted to 9 with a 40% benzyltrimethylammonium hydroxide (methanol) solution. Thirty minutes later, a modified pigment dispersion was obtained. Ultrafiltration with a permeable membrane was performed using the dispersion containing the pigment to which a carboxylic acid group, or a carboxylic acid benzyltrimethylammonium salt, or both were bonded, and ion-exchanged ultrapure water, and the resultant was further subjected to ultrasonic dispersion, to thereby obtain a modified pigment dispersion the pigment solid content of which had been concentrated to 20% by weight. The volume-average particle diameter (D50) as measured by a particle size distribution measuring device (NANOTRACK UPA-EX150 from Nikkiso Co., Ltd.) was 100 nm.

### Preparation Example 5

### Preparation of Surface Modified Black Pigment Dispersion V

One (1) kg of SENSIJET Black SDP2000 (pigment solid content 14.5% from Sensient Technologies Corp.) was subjected to acid deposition with a 0.1 NHCl aqueous solution. Subsequently, pH of the resultant was adjusted to 9 with a 10% tetrabutylammonium hydroxide (methanol) solution. Thirty minutes later, a modified pigment dispersion was obtained. Ultrafiltration with a permeable membrane was performed using the dispersion containing the pigment to which a carboxylic (sulfonic) acid group, a carboxylic (sulfonic) acid tetrabutylammonium salt, or both were bonded, and ion-exchanged ultrapure water, and the resultant was further subjected to ultrasonic dispersion, to thereby obtain a modified pigment dispersion the pigment solid content of which had been concentrated to 20% by weight. The volume-average particle diameter (D50) as measured by a particle size distribution measuring device (NANOTRACK UPA-EX150 from Nikkiso Co., Ltd.) was 120 nm.

### Preparation Example 6

### Preparation of Surface Modified Magenta Pigment Dispersion I

One (1) kg of SMART Magenta 3122BA (surface-treated Pigment Red 122 dispersion, pigment solid content 14.5%) from Sensient Technologies Corporation was subjected to acid deposition with a 0.1 NHCl aqueous solution. Subsequently, pH of the resultant was adjusted to 9 with a 10% tetraethylammonium hydroxide (methanol) solution. Thirty minutes later, a modified pigment dispersion was obtained. Ultrafiltration with a permeable membrane was performed using the dispersion containing the pigment to which a an amino benzoic acid group, or an amino benzoic acid tetraethylammonium salt, or both were bonded, and ion-exchanged ultrapure water, and the resultant was further subjected to ultrasonic dispersion, to thereby obtain a modified pigment dispersion the pigment solid content of which had been concentrated to 20% by weight. The volume-average particle diameter (D50) as measured by a particle size distribution measuring device (NANOTRACK UPA-EX150 from Nikkiso Co., Ltd.) was 104 nm.

### Preparation Example 7

### Preparation of Surface Modified Cyan Pigment Dispersion I

One (1) kg of SMART Cyan 3154BA (surface-treated Pigment Blue 15:4 dispersion, pigment solid content 14.5%) from Sensient Technologies Corporation was subjected to acid deposition with a 0.1 NHCl aqueous solution. Subsequently, pH of the resultant was adjusted to 9 with a 40% benzyltrimethylammonium hydroxide (methanol) solution. Thirty minutes later, a modified pigment dispersion was obtained. Ultrafiltration with a permeable membrane was performed using the dispersion containing the pigment to which a an amino benzoic acid group, or an amino benzoic acid benzyltrimethylammonium salt, or both were bonded, and ion-exchanged ultrapure water, and the resultant was further subjected to ultrasonic dispersion, to thereby obtain a modified pigment dispersion the pigment solid content of which had been concentrated to 20% by weight. The volume-average particle diameter (D50) as measured by a particle size distribution measuring device (NANOTRACK UPA-EX150 from Nikkiso Co., Ltd.) was 116 nm.

### Preparation Example 8

### Preparation of Surface Modified Yellow Pigment Dispersion I

One (1) kg of SMART Yellow 3074BA (surface-treated Pigment Yellow 74 dispersion, pigment solid content 14.5%) from Sensient Technologies Corporation was subjected to acid deposition with a 0.1 NHCl aqueous solution. Subsequently, pH of the resultant was adjusted to 9 with a 10% tetrabutylammonium hydroxide (methanol) solution. Thirty minutes later, a modified pigment dispersion was obtained. Ultrafiltration with a permeable membrane was performed using the dispersion containing the pigment to which a an amino benzoic acid group, or an amino benzoic acid tetrabutylammonium salt, or both were bonded, and ion-exchanged ultrapure water, and the resultant was further subjected to ultrasonic dispersion, to thereby obtain a modified pigment dispersion the pigment solid content of which had been concentrated to 20% by weight. The volume-average particle diameter (D50) as measured by a particle size distribution measuring device (NANOTRACK UPA-EX150 from Nikkiso Co., Ltd.) was 145 nm.

### Preparation Example 9

### Preparation of Carbon Black Pigment-Containing Polymer Particle Dispersion

### —Preparation of Polymer Solution A—

After sufficiently purging a 1 L flask equipped with a mechanical stirrer, a thermometer, a nitrogen inlet tube, a reflux tube, and a dripping funnel with nitrogen gas, the flask was charged with 11.2 g of styrene, 2.8 g of acrylic acid, 12.0 g of lauryl methacrylate, 4.0 g of polyethylene glycol methacrylate, 4.0 g of styrene macromer, and 0.4 g of mercapto ethanol, and the mixture was mixed and heated to 65° C. Next, a mixed solution of styrene (100.8 g), acrylic acid (25.2 g), lauryl methacrylate (108.0 g), polyethylene glycol methacrylate (36.0 g), hydroxyethyl methacrylate (60.0 g), styrene macromer (36.0 g), mercapto ethanol (3.6 g), azobis methylvaleronitrile (2.4 g), and methyl ethyl ketone (18 g) was added dropwise into the flask over 2.5 hours. After the dripping, a mixed solution of azobis methylvaleronitrile (0.8 g) and methyl ethyl ketone (18 g) was added dropwise into the flask over 0.5 hours. After aging the mixture at 65° C. for 1 hour, 0.8 g of azobis methylvaleronitrile was added, and the resultant was further aged for 1 hour. Upon completion of the reaction, methyl ethyl ketone (364 g) was added to the flask, to thereby obtain 800 g of Polymer Solution A having a concentration of 50% by weight.

### —Preparation of Carbon Black Pigment-Containing Polymer Particle Dispersion—

After sufficiently stirring a mixture of Polymer Solution A (28 g), C.I. Carbon Black FW100 from Degussa AG (42 g), a 1 mol/L potassium hydroxide aqueous solution (13.6 g), methyl ethyl ketone (20 g), and ion-exchanged water (13.6 g), the resulting mixture was kneaded by a roll mill. To the obtained paste, 200 g of pure water was added, the resulting mixture was sufficiently stirred, and methyl ethyl ketone and water were removed from the resultant using an evaporator, followed by subjecting the resultant to pressure filtration with a polyvinylidene fluoride membrane filter having the average pore diameter of 5.0 μm to remove coarse particles, to thereby obtain a magenta pigment-containing polymer dispersion liquid having a pigment solid content of 15% by weight, and solid content of 20% by weight.

The volume average particle diameter (D50) of the polymer particles in the obtained magenta pigment-containing polymer particle dispersion liquid was measured by a particle size distribution measuring device (NANOTRACK UPA-EX150, manufactured by Nikkiso Co., Ltd.), and the result was 104 nm.

### Example 1

### Preparation of Ink for Inkjet Recording

First, a hydrosoluble organic solvent (wetter), a penetrant, a surfactant, an antifungal agent, and water were blended as depicted in Table 3, and the resulting mixture was stirred for 1 hour to homogeneously mix the mixture. Depending on the mixed liquid, moreover, an ink was prepared by adding a hydrodispersible resin followed by stirring for 1 hour, and then adding a hydrodispersible colorant (pigment dispersion), a defoamer and a pH regulator, followed by stirring for 1 hour. The resulting ink was subjected to pressure filtration using a polyvinylidene fluoride membrane filter having the average pore diameter of 1.2 μm to remove coarse particles and dusts, to thereby obtain an ink for inkjet recording Example 1.

### Examples 2 to 13 and Comparative Examples 1 to 8

The procedure for preparation of the ink for inkjet recording in Example 1 was repeated to prepare inks for inkjet recording of Examples 2 to 13 and Comparative Examples 1 to 8 except for changing the formulations as shown in Table 3.

TABLE 3

| Ingredient (% by weight) | | Ex. 1 | Ex. 2 | Ex. 3 | Ex. 4 | Ex. 5 |
|---|---|---|---|---|---|---|
| Hydro- | Surface modified black pigment | 37.50 | 37.50 | — | — | |
| dispersible | dispersion I (Prep. Ex. 1) | | | | | |
| colorant | Surface modified black pigment | — | — | 37.50 | — | — |
| (pigment | dispersion II (Prep. Ex. 2) | | | | | |
| dispersion) | Surface modified black pigment | — | — | — | 37.50 | — |
| | dispersion III (Prep. Ex. 3) | | | | | |
| | Surface modified black pigment | — | — | — | — | 37.50 |
| | dispersion IV (Prep. Ex. 4) | | | | | |
| | Surface modified black pigment | — | — | — | — | — |
| | dispersion V (Prep. Ex. 5) | | | | | |
| | Surface modified magenta pigment | — | — | — | — | — |
| | dispersion I (Prep. Ex. 6) | | | | | |
| | Surface modified cyan pigment | — | — | — | — | — |
| | dispersion IV (Prep. Ex. 7) | | | | | |
| | Surface modified yellow pigment | — | — | — | — | — |
| | dispersion I (Prep. Ex. 8) | | | | | |
| | SENSIJET SMART Magenta | — | — | — | — | — |
| | 3122BA | | | | | |
| | (amino benzoic acid sodium salt) | | | | | |
| | SENSIJET SMART Cyan 3154BA | — | — | — | — | — |
| | (amino benzoic acid sodium salt) | | | | | |
| | SENSIJET SMART yellow 3074BA | — | — | — | — | — |
| | (amino benzoic acid sodium salt) | | | | | |
| | SENSIJET Black SDP2000 | | — | — | — | — |
| | (carboxylic acid sodium salt, sulfonic | | | | | |
| | acid sodium salt) | | | | | |
| | Carbon Black Pigment-Containing | — | — | — | — | — |
| | Polymer Particle Dispersion | | | | | |
| | (Preparation Example 9) | | | | | |
| Hydro- | Acryl-silicone resin emulsion | — | 5.00 | — | — | — |
| dispersible | Fluororesin emulsion | — | — | — | — | — |
| resin | | | | | | |
| Organic | 3-ethyl-3-hydroxymethyloxetane | 50.00 | 40.00 | — | — | — |
| solvent | (SP Value: 11.3) | | | | | |
| | 3-methyl-1,3-butanediol | — | — | 50.00 | — | — |
| | (SP Value: 12.1) | | | | | |
| | 1,3-butanediol (SP Value: 12.8) | — | — | — | 50.00 | — |
| | 1,2-butanediol (SP Value: 12.8) | — | — | — | — | 50.00 |
| | 2,3-butanediol (SP Value: 12.5) | — | — | — | — | — |
| | 1,2-propanediol (SP Value: 13.5) | — | — | — | — | — |
| | 1,3-propanediol (SP Value: 13.7) | — | — | — | — | — |
| | 1,2-hexanediol (SP Value: 11.8) | — | — | — | — | — |
| Wetter | Glycerin (SP Value: 16.38) | — | — | — | — | — |
| | Triethyleneglycol (SP Value: 15.4) | — | — | — | — | — |
| Penetrant | 2-ethyl-1,3-hexanediol | 2.00 | 2.00 | — | — | — |
| | (SP Value: 10.6) | | | | | |
| | 2,2,4-trimethyl-1,3-pentanediol | — | — | 2.00 | 2.00 | 2.00 |
| | (SP Value: 10.8) | | | | | |
| Surfactant | KF-643 | — | — | 1.00 | — | — |
| | Zonyl FS-300 | — | — | — | 2.50 | — |
| | Compound having the formula (3)-(q) | 0.50 | 0.50 | — | — | — |
| | Surfynol 104E | — | — | — | — | 1.00 |
| | Softanol EP-7025 | — | — | — | — | — |
| Antifungal | Proxel GXL | 0.05 | 0.05 | 0.05 | 0.05 | 0.05 |
| agent | | | | | | |
| Foam | 2,4,7,9-tetramethyldecane-4,7-diol | — | — | — | — | 0.40 |
| inhibitor | 2,5,8,11-tetramethyldodecane-5,8- | — | — | 0.40 | 0.40 | — |
| (defoamer) | diol | | | | | |
| pH | 2-amino-2-ethyl-1,3-propanediol | 0.20 | 0.20 | 0.20 | 0.10 | 0.10 |
| regulator | | | | | | |
| Pure water | | Balance | Balance | Balance | Balance | Balance |
| Total (% by weight) | | 100 | 100 | 100 | 100 | 100 |
| Ingredient (% by weight) | | Ex. 6 | Ex. 7 | Ex. 8 | Ex. 9 | Ex. 10 |
| Hydro- | Surface modified black pigment | — | 37.50 | 37.50 | 37.50 | — |
| dispersible | dispersion I (Prep. Ex. 1) | | | | | |
| colorant | Surface modified black pigment | — | — | — | — | — |
| (pigment | dispersion II (Prep. Ex. 2) | | | | | |
| dispersion) | Surface modified black pigment | — | — | — | | — |
| | dispersion III (Prep. Ex. 3) | | | | | |
| | Surface modified black pigment | — | — | — | — | |
| | dispersion IV (Prep. Ex. 4) | | | | | |
| | Surface modified black pigment | 37.50 | — | — | — | — |
| | dispersion V (Prep. Ex. 5) | | | | | |
| | Surface modified magenta pigment | — | — | — | — | — |
| | dispersion I (Prep. Ex. 6) | | | | | |
| | Surface modified cyan pigment | — | — | — | — | — |
| | dispersion IV (Prep. Ex. 7) | | | | | |
| | Surface modified yellow pigment | — | — | — | — | — |
| | dispersion I (Prep. Ex. 8) | | | | | |
| | SENSIJET SMART Magenta | — | — | — | — | — |
| | 3122BA | | | | | |
| | (amino benzoic acid sodium salt) | | | | | |
| | SENSIJET SMART Cyan 3154BA | — | — | — | — | — |
| | (amino benzoic acid sodium salt) | | | | | |
| | SENSIJET SMART yellow 3074BA | — | — | — | — | — |
| | (amino benzoic acid sodium salt) | | | | | |
| | SENSIJET Black SDP2000 | — | — | — | — | — |
| | (carboxylic acid sodium salt, sulfonic | | | | | |
| | acid sodium salt) | | | | | |
| | Carbon Black Pigment-Containing | — | — | — | — | — |
| | Polymer Particle Dispersion | | | | | |
| | (Preparation Example 9) | | | | | |
| Hydro- | Acryl-silicone resin emulsion | — | — | — | — | — |
| dispersible | Fluororesin emulsion | — | — | — | — | 4.00 |
| resin | | | | | | |
| Organic | 3-ethyl-3-hydroxymethyloxetane | — | — | — | — | 40.00 |
| solvent | (SP Value: 11.3) | | | | | |
| | 3-methyl-1,3-butanediol | — | — | — | — | — |
| | (SP Value: 12.1) | | | | | |
| | 1,3-butanediol (SP Value: 12.8) | — | — | — | — | — |
| | 1,2-butanediol (SP Value: 12.8) | — | — | — | — | — |
| | 2,3-butanediol (SP Value: 12.5) | 50.00 | — | — | — | — |
| | 1,2-propanediol (SP Value: 13.5) | — | 50.00 | — | — | — |
| | 1,3-propanediol (SP Value: 13.7) | — | — | 50.00 | — | — |
| | 1,2-hexanediol (SP Value: 11.8) | — | — | — | 50.00 | — |
| Wetter | Glycerin (SP Value: 16.38) | — | — | — | — | — |
| | Triethyleneglycol (SP Value: 15.4) | — | — | — | — | — |
| Penetrant | 2-ethyl-1,3-hexanediol | — | 2.00 | 2.00 | 2.00 | 2.0 |
| | (SP Value: 10.6) | | | | | |
| | 2,2,4-trimethyl-1,3-pentanediol | — | — | — | — | — |
| | (SP Value: 10.8) | | | | | |
| Surfactant | KF-643 | — | — | — | — | — |
| | Zonyl FS-300 | — | — | — | — | 2.50 |
| | Compound having the formula (3)-(q) | — | 0.30 | 0.30 | 0.30 | — |
| | Surfynol 104E | — | — | — | — | — |
| | Softanol EP-7025 | 1.00 | — | 2.00 | — | — |
| Antifungal | Proxel GXL | 0.05 | 0.05 | 0.05 | 0.05 | 0.05 |
| agent | | | | | | |
| Foam | 2,4,7,9-tetramethyldecane-4,7-diol | 0.40 | 0.40 | 0.40 | 0.40 | 0.40 |
| inhibitor | 2,5,8,11-tetramethyldodecane-5,8- | — | — | — | — | — |
| (defoamer) | diol | | | | | |
| pH | 2-amino-2-ethyl-1,3-propanediol | 0.20 | 0.20 | 0.20 | 0.20 | 0.20 |
| regulator | | | | | | |
| Pure water | | Balance | Balance | Balance | Balance | Balance |
| Total (% by weight) | | 100 | 100 | 100 | 100 | 100 |
| | | | | | Com. | Com. |
| Ingredient (% by weight) | | Ex. 11 | Ex. 12 | Ex. 13 | Ex. 1 | Ex. 2 |
| Hydro- | Surface modified black pigment | — | — | 37.50 | 37.50 | 37.50 |
| dispersible | dispersion I (Prep. Ex. 1) | | | | | |
| colorant | Surface modified black pigment | — | — | — | — | — |
| (pigment | dispersion II (Prep. Ex. 2) | | | | | |
| dispersion) | Surface modified black pigment | — | — | — | — | — |
| | dispersion III (Prep. Ex. 3) | | | | | |
| | Surface modified black pigment | — | — | — | — | — |
| | dispersion IV (Prep. Ex. 4) | | | | | |
| | Surface modified black pigment | — | — | — | — | — |
| | dispersion V (Prep. Ex. 5) | | | | | |
| | Surface modified magenta pigment | — | — | — | — | — |
| | dispersion I (Prep. Ex. 6) | | | | | |
| | Surface modified cyan pigment | 22.50 | — | — | — | — |
| | dispersion IV (Prep. Ex. 7) | | | | | |
| | Surface modified yellow pigment | — | 20.00 | — | — | — |
| | dispersion I (Prep. Ex. 8) | | | | | |
| | SENSIJET SMART Magenta | — | — | — | — | — |
| | 3122BA | | | | | |
| | (amino benzoic acid sodium salt) | | | | | |
| | SENSIJET SMART Cyan 3154BA | — | — | — | — | — |
| | (amino benzoic acid sodium salt) | | | | | |
| | SENSIJET SMART yellow 3074BA | — | — | — | — | — |
| | (amino benzoic acid sodium salt) | | | | | |
| | SENSIJET Black SDP2000 | — | — | — | — | — |
| | (carboxylic acid sodium salt, sulfonic | | | | | |
| | acid sodium salt) | | | | | |
| | Carbon Black Pigment-Containing | — | — | — | — | — |
| | Polymer Particle Dispersion | | | | | |
| | (Preparation Example 9) | | | | | |
| Hydro- | Acryl-silicone resin emulsion | — | — | — | — | — |
| dispersible | Fluororesin emulsion | — | — | — | — | — |
| resin | | | | | | |
| Organic | 3-ethyl-3-hydroxymethyloxetane | 65.00 | 68.00 | 35.00 | — | — |
| solvent | (SP Value: 11.3) | | | | | |
| | 3-methyl-1,3-butanediol | — | — | — | — | — |
| | (SP Value: 12.1) | | | | | |
| | 1,3-butanediol (SP Value: 12.8) | — | — | — | — | — |
| | 1,2-butanediol (SP Value: 12.8) | — | — | — | — | — |
| | 2,3-butanediol (SP Value: 12.5) | — | — | — | — | — |
| | 1,2-propanediol (SP Value: 13.5) | — | — | — | — | — |
| | 1,3-propanediol (SP Value: 13.7) | — | — | — | — | — |
| | 1,2-hexanediol (SP Value: 11.8) | — | — | — | — | — |
| Wetter | Glycerin (SP Value: 16.38) | — | — | — | 50.00 | — |
| | Triethyleneglycol (SP Value: 15.4) | — | — | — | — | 50.00 |
| Penetrant | 2-ethyl-1,3-hexanediol | 2.00 | 2.00 | — | 2.00 | 2.00 |
| | (SP Value: 10.6) | | | | | |
| | 2,2,4-trimethyl-1,3-pentanediol | — | — | — | — | — |
| | (SP Value: 10.8) | | | | | |
| Surfactant | KF-643 | 1.00 | 1.00 | — | — | — |
| | Zonyl FS-300 | — | — | — | — | — |
| | Compound having the formula (3)-(q) | — | — | 0.50 | 0.50 | 0.50 |
| | Surfynol 104E | — | — | — | — | — |
| | Softanol EP-7025 | — | — | — | — | — |
| Antifungal | Proxel GXL | 0.05 | 0.05 | 0.05 | 0.05 | 0.05 |
| agent | | | | | | |
| Foam | 2,4,7,9-tetramethyldecane-4,7-diol | 0.40 | 0.40 | 0.60 | 0.50 | 0.50 |
| inhibitor | 2,5,8,11-tetramethyldodecane-5,8- | — | — | — | — | — |
| (defoamer) | diol | | | | | |
| pH | 2-amino-2-ethyl-1,3-propanediol | 0.20 | 0.20 | 0.20 | 0.20 | 0.20 |
| regulator | | | | | | |
| Pure water | | Balance | Balance | Balance | Balance | Balance |
| Total (% by weight) | | 100 | 100 | 100 | 100 | 100 |
| | | Com. | Com. | Com. | Com. | Com. |
| Ingredient (% by weight) | | Ex. 3 | Ex. 4 | Ex. 5 | Ex. 6 | Ex. 7 |
| Hydro- | Surface modified black pigment | 37.50 | — | — | — | — |
| dispersible | dispersion I (Prep. Ex. 1) | | | | | |
| colorant | Surface modified black pigment | — | — | — | — | — |
| (pigment | dispersion II (Prep. Ex. 2) | | | | | |
| dispersion) | Surface modified black pigment | — | — | — | — | — |
| | dispersion III (Prep. Ex. 3) | | | | | |
| | Surface modified black pigment | — | — | — | — | — |
| | dispersion IV (Prep. Ex. 4) | | | | | |
| | Surface modified black pigment | — | — | — | — | — |
| | dispersion V (Prep. Ex. 5) | | | | | |
| | Surface modified magenta pigment | — | — | — | — | — |
| | dispersion I (Prep. Ex. 6) | | | | | |
| | Surface modified cyan pigment | — | — | — | — | — |
| | dispersion IV (Prep. Ex. 7) | | | | | |
| | Surface modified yellow pigment | — | — | — | — | — |
| | dispersion I (Prep. Ex. 8) | | | | | |
| | SENSIJET SMART Magenta | — | — | — | 37.5 | — |
| | 3122BA | | | | | |
| | (amino benzoic acid sodium salt) | | | | | |
| | SENSIJET SMART Cyan 3154BA | — | — | — | — | 22.50 |
| | (amino benzoic acid sodium salt) | | | | | |
| | SENSIJET SMART yellow 3074BA | — | — | — | — | — |
| | (amino benzoic acid sodium salt) | | | | | |
| | SENSIJET Black SDP2000 | — | 37.50 | — | — | — |
| | (carboxylic acid sodium salt, sulfonic | | | | | |
| | acid sodium salt) | | | | | |
| | Carbon Black Pigment-Containing | — | — | 50.00 | — | — |
| | Polymer Particle Dispersion | | | | | |
| | (Preparation Example 9) | | | | | |
| Hydro- | Acryl-silicone resin emulsion | — | — | — | — | — |
| dispersible | Fluororesin emulsion | — | — | — | 4.00 | — |
| resin | | | | | | |
| Organic | 3-ethyl-3-hydroxymethyloxetane | — | 50.00 | 40.00 | 40.0 | 65.00 |
| solvent | (SP Value: 11.3) | | | | | |
| | 3-methyl-1,3-butanediol | — | — | — | — | — |
| | (SP Value: 12.1) | | | | | |
| | 1,3-butanediol (SP Value: 12.8) | — | — | — | — | — |
| | 1,2-butanediol (SP Value: 12.8) | — | — | — | — | — |
| | 2,3-butanediol (SP Value: 12.5) | — | — | — | — | — |
| | 1,2-propanediol (SP Value: 13.5) | — | — | — | — | — |
| | 1,3-propanediol (SP Value: 13.7) | — | — | — | — | — |
| | 1,2-hexanediol (SP Value: 11.8) | — | — | — | — | — |
| Wetter | Glycerin (SP Value: 16.38) | — | — | — | — | — |
| | Triethyleneglycol (SP Value: 15.4) | — | — | — | — | — |
| Penetrant | 2-ethyl-1,3-hexanediol | 50.00 | 2.00 | 2.00 | 2.00 | 2.00 |
| | (SP Value: 10.6) | | | | | |
| | 2,2,4-trimethyl-1,3-pentanediol | — | — | — | — | — |
| | (SP Value: 10.8) | | | | | |
| Surfactant | KF-643 | — | — | — | — | 1.00 |
| | Zonyl FS-300 | — | — | — | 2.50 | — |
| | Compound having the formula (3)-(q) | 0.50 | 0.50 | 0.50 | — | — |
| | Surfynol 104E | — | — | — | — | — |
| | Softanol EP-7025 | — | — | — | — | — |
| Antifungal | Proxel GXL | 0.05 | 0.05 | 0.05 | 0.05 | 0.05 |
| agent | | | | | | |
| Foam | 2,4,7,9-tetramethyldecane-4,7-diol | 0.50 | 0.50 | 0.50 | 0.40 | 0.40 |
| inhibitor | 2,5,8,11-tetramethyldodecane-5,8- | — | — | — | — | — |
| (defoamer) | diol | | | | | |
| pH | 2-amino-2-ethyl-1,3-propanediol | 0.20 | 0.20 | 0.20 | 0.20 | 0.20 |
| regulator | | | | | | |

| | | | | | |
|---|---|---|---|---|---|
| Pure water | Balance | Balance | Balance | Balance | Balance |
| Total (% by weight) | 100 | 100 | 100 | 100 | 100 |

| | | Com. |
|---|---|---|
| Ingredient (% by weight) | | Ex. 8 |
| Hydro- | Surface modified black pigment | — |
| dispersible | dispersion I (Prep. Ex. 1) | |
| colorant | Surface modified black pigment | — |
| (pigment | dispersion II (Prep. Ex. 2) | |
| dispersion) | Surface modified black pigment | — |
| | dispersion III (Prep. Ex. 3) | |
| | Surface modified black pigment | — |
| | dispersion IV (Prep. Ex. 4) | |
| | Surface modified black pigment | — |
| | dispersion V (Prep. Ex. 5) | |
| | Surface modified magenta pigment | — |
| | dispersion I (Prep. Ex. 6) | |
| | Surface modified cyan pigment | — |
| | dispersion IV (Prep. Ex. 7) | |
| | Surface modified yellow pigment | — |
| | dispersion I (Prep. Ex. 8) | |
| | SENSIJET SMART Magenta | — |
| | 3122BA | |
| | (amino benzoic acid sodium salt) | |
| | SENSIJET SMART Cyan 3154BA | 20.0 |
| | (amino benzoic acid sodium salt) | |
| | SENSIJET SMART yellow 3074BA | — |
| | (amino benzoic acid sodium salt) | |
| | SENSIJET Black SDP2000 | — |
| | (carboxylic acid sodium salt, sulfonic | |
| | acid sodium salt) | |
| | Carbon Black Pigment-Containing | — |
| | Polymer Particle Dispersion | |
| | (Preparation Example 9) | |
| Hydro- | Acryl-silicone resin emulsion | — |
| dispersible | Fluororesin emulsion | — |
| resin | | |
| Organic | 3-ethyl-3-hydroxymethyloxetane | 68.0 |
| solvent | (SP Value: 11.3) | |
| | 3-methyl-1,3-butanediol | — |
| | (SP Value: 12.1) | |
| | 1,3-butanediol (SP Value: 12.8) | — |
| | 1,2-butanediol (SP Value: 12.8) | — |
| | 2,3-butanediol (SP Value: 12.5) | — |
| | 1,2-propanediol (SP Value: 13.5) | — |
| | 1,3-propanediol (SP Value: 13.7) | — |
| | 1,2-hexanediol (SP Value: 11.8) | — |
| Wetter | Glycerin (SP Value: 16.38) | — |
| | Triethyleneglycol (SP Value: 15.4) | — |
| Penetrant | 2-ethyl-1,3-hexanediol | 2.00 |
| | (SP Value: 10.6) | |
| | 2,2,4-trimethyl-1,3-pentanediol | — |
| | (SP Value: 10.8) | |
| Surfactant | KF-643 | 1.00 |
| | Zonyl FS-300 | — |
| | Compound having the formula (3)-(q) | — |
| | Surfynol 104E | — |
| | Softanol EP-7025 | — |
| Antifungal | Proxel GXL | 0.05 |
| agent | | |
| Foam | 2,4,7,9-tetramethyldecane-4,7-diol | 0.40 |
| inhibitor | 2,5,8,11-tetramethyldodecane-5,8- | — |
| (defoamer) | diol | |
| pH | 2-amino-2-ethyl-1,3-propanediol | 0.20 |
| regulator | | |

| | |
|---|---|
| Pure water | Balance |
| Total (% by weight) | 100 |

Acryl-silicone resin emulsion: POLYZOL ROY6312 manufactured by Showa Highpolymer Co., Ltd., solid content: 37.2% by weight, the volume average particle diameter: 171 nm, minimum film forming temperature (MFT): 20° C.
Fluororesin Emulsion B: LUMIFLON FE4500, manufactured by ASAHI GLASS CO., LTD., solid content: 50% by weight, the average particle diameter: 150 nm, MFT: 30° C.
KF-643: polyether-modified silicone compound (manufactured by Shin-Etsu Chemical Co., Ltd., ingredient: 100% by weight)
Zonyl FS-300: polyoxyethylene perfluoroalkyl ether (manufactured by Du Pont Kabushiki Kaisha, active ingredient: 40% by weight)
Surfynol 104E: an acetylene glycol-based compound (manufactured by Nissin Chemical Industry Co., Ltd., active ingredient: 50% by weight, containing ethylene glycol)
Softanol EP-7025: polyoxyalkylene alkyl ether (manufactured by NIPPON SHOKUBAI CO., LTD., ingredient: 100% by weight)
Proxel GXL: an antifungal agent containing 1,2-benzothiazolin-3-one as a main ingredient (manufactured by Avecia Inc., ingredient: 20% by weight, containing dipropylene glycol)

Next, the physical properties of each of the inks for inkjet recording of Examples 1 to 13 and Comparative Examples 1 to 8 were measured. The results are shown in Table 4.

### <Viscosity>

The viscosity of the ink was measured at 25° C. by means of a viscometer (RE-550L from Toki Sangyo Co., Ltd.).

<pH>

The pH of the ink was measured at 25° C. using a pH meter (HM-30R, manufactured by TOA-DKK CORPORATION).

### <Dynamic Surface Tension>

The dynamic surface tension as measured by the maximum bubble pressure method with surface lifetime of 1500 ms was measured at 25° C. by means of SITA DynoTester (from SITA Messtechnik).

### <Water Evaporation Viscosity Measurement>

On a glass petri dish of 33 mm caliber, 2.5 g of the ink measured by a precision upper plate electron balance capable of measuring to four decimal places were placed. The ink was stored in a thermo hygrostat Model PL-3KP from Espec Corp. at 23±0.5° C. and 15±5% RH under normal pressure, and the weight and the ink residue viscosity were measured every 30 min for 5 hrs. Next, the water evaporation rate and the ink residue viscosity were graphed to read the viscosity when the water evaporation rate is 30%. (viscosity when the water evaporation rate is 30%: 100 mPa·s or more is poor discharge reliability)

The ink residue was measured by a viscometer RE-550L from Toki Sangyo Co., Ltd. at 25° C.

Water evaporation rate(% by weight)=(1−ink residue weight/ink weight before water evaporates)×100

*It is assumed only water evaporates in the ink.

TABLE 4

| | Physical properties values of ink | | | |
|---|---|---|---|---|
| | | | 1500 ms | Water |
| | Viscosity | | dynamic surface | Evaporation |
| | (mPa · s) | pH | tension (mN/m) | Viscosity |
| Example 1 | 8.4 | 9.5 | 21.5 | 33 |
| Example 2 | 8.0 | 9.6 | 20.9 | 37 |
| Example 3 | 16.9 | 9.7 | 24.6 | 83 |
| Example 4 | 12.9 | 9.6 | 24.7 | 73 |
| Example 5 | 13.8 | 9.4 | 26.6 | 82 |
| Example 6 | 13.7 | 9.4 | 31.6 | 84 |
| Example 7 | 9.4 | 9.7 | 23.1 | 47 |
| Example 8 | 8.9 | 9.5 | 22.9 | 42 |
| Example 9 | 10.9 | 9.3 | 23.6 | 56 |
| Example 10 | 8.2 | 9.4 | 21.3 | 39 |
| Example 11 | 10.5 | 9.6 | 25.7 | 89 |
| Example 12 | 10.4 | 9.5 | 25.2 | 82 |
| Example 13 | 6.5 | 9.6 | 20.2 | 26 |
| Comparative | 10.9 | 9.7 | 21.8 | 188 |
| Example 1 | | | | |
| Comparative | 11.3 | 9.5 | 22.0 | 216 |
| Example 2 | | | | |
| Comparative | The ink was separated into oil and water | | | |
| Example 3 | layers (unmeasurable) | | | |
| Comparative | 8.4 | 9.9 | 20.7 | 1200< |
| Example 4 | | | | |
| Comparative | 9.9 | 9.4 | 22.2 | 1200< |
| Example 5 | | | | |
| Comparative | 8.3 | 9.4 | 21.3 | 1200< |
| Example 6 | | | | |
| Comparative | 11.2 | 9.6 | 26.0 | 1200< |
| Example 7 | | | | |
| Comparative | 11.0 | 9.5 | 25.8 | 1200< |
| Example 8 | | | | |

### —Inkjet Step (Image Forming Step)—

Next, an inkjet recording device (IPSIO GXe-5500, manufactured by Ricoh Company Limited) was set under the environmental conditions controlled to be the temperature of 23° C.±0.5° C., and the relative humidity of 50%±5% in the following manner. The driving voltage of a piezo element was varied to give the same ejecting amount of the ink, so that the same amount of the ink is deposited onto a recording medium (My Paper from Ricoh Company, Ltd.). The printing mode of the inkjet recording device was set to “plain paper-fast.”

Next, Examples 1 to 13 and Comparative Examples 1 to 8 were evaluated in the following manners. The results are shown in Table 5.

### <Image Density>

A chart including a 64-point symbol “▪” produced using Microsoft Word 2000 (of Microsoft) was printed on each recording medium. The color in the “▪” portions on a printed surface was measured by X-Rite939, and the result was evaluated based on the following evaluation criteria. As for the printing mode, “Plain Paper-Standard Fast” mode was changed to the “No Color Correction” mode by using a driver that accompanied a printer.

[Evaluation Standard]

Excellent: 1.25 or higher in Black, 0.8 or higher in Yellow, 1.0 or higher in Magenta, and 1.5 or higher in Cyan.

Good: 1.20 or higher but lower than 1.25 in Black, 0.75 or higher but lower than 0.8 in Yellow, 0.95 or higher but lower than 1.0 in Magenta, and 1.0 or higher but lower than 1.05 in Cyan.

Fair: 1.15 or higher but lower than 1.20 in Black, 0.70 or higher but lower than 0.75 in Yellow, 0.90 or higher but lower than 0.95 in Magenta, and 0.95 or higher but lower than 1.00 in Cyan.

Poor: lower than 1.15 in Black, lower than 0.7 in Yellow, lower than 0.9 in Magenta, and lower than 0.95 in Cyan.

### <Curl>

A solid image was produced using a trial line head printer in FIG. 3 under the following printing conditions, and back curl (image side down) height after the image was left for 10 sec and 1 day were measured and evaluated, based on the following evaluation standard.

(1) Evaluation printer: Trial line head printer (FIG. 3)

(2) Evaluation media: My Paper (PPC) from Ricoh Company, Ltd.

(3) Printing conditions: recoding density→300×600 dpi, printed area→526.3 cm²/A4, discharged ink amount→5.6 g/m²

(4) Evaluation environment: 23±0.5° C., 50±5% RH

(5) Curl measurement: Curl heights just after a printed paper is printed (in 10 sec after discharged from the printer) and after left for one day were measured. The A4 size My paper was placed still on a flat desk with the curled surface up, and heights of four corners thereof were measured with a JIS_{—}1 class scale and an average of the heights was determined. When the curl was so large that the paper was cylindrically curled, a diameter thereof was measured.

[Evaluation Standard]

Excellent: less than 10 mm

Good: 10 mm or more and less than 40 mm

Fair: 40 mm or more

Poor: Cylindrically curled

### <Discharge Stability>

Two hundred (200) sheets of a chart of solid images having an area ratio of 5% per color made by Microsoft Word 2000 were continuously printed on My Paper A4 size from Ricoh Company, Ltd. and disturbance of ink discharging by each nozzle was evaluated after printing. As for the printing mode, “Plain Paper-Standard Fast” mode was changed to “No Color Correction” mode by using a driver residing in a printer.

[Evaluation Standard]

Good: No disturbance

Fair: Slight disturbance

Poor: Disturbed or not discharged partially

### <Ink Storage Stability>

The viscosity of the ink before stored and after stored in a sealed container at 70° C. for 7 days were measured. The ink storage stability was evaluated under the following standard.

Ink Storage Stability(%)=[(viscosity after stored)/(Viscosity before stored)]×100

[Evaluation Standard]

Good: less than 100±10%

Fair: 100±10% or more and less than less than 100±20%

Poor: 100±20% or more

### <Ink Anchorage in Retainer>

An inkjet recording device (IPSIO GXe-5500, manufactured by Ricoh Company Limited) was set using the ink under the environmental conditions controlled to be the temperature of 23° C.±0.5° C., and the relative humidity of 50%±5% in the following manner. After the driving voltage of a piezo element was varied to give the same ejecting amount of the ink so that the same amount of the ink is deposited onto a recording medium, the head cleaning operation was continuously performed 10 times for 1 hr, and totally 100 times for 10 hrs. The ink anchorage on the wiper and the wiper cleaner of the retainer was visually observed after left for 12 hrs.

Good: No ink anchorage was observed

Fair: Slight ink anchorage was observed

Poor: Ink anchorage was observed

TABLE 5

| | | Curl | | | | |
|---|---|---|---|---|---|---|
| | Image | Just | One day | Discharge | Storage | Ink |
| | density | after printed | after printed | stability | stability | anchorage |
| Example 1 | Excellent | Good | Excellent | Good | Good | Good |
| Example 2 | Good | Good | Excellent | Good | Good | Good |
| Example 3 | Good | Good | Excellent | Good | Good | Good |
| Example 4 | Good | Good | Excellent | Good | Good | Good |
| Example 5 | Good | Good | Excellent | Good | Good | Good |
| Example 6 | Fair | Good | Excellent | Good | Good | Good |
| Example 7 | Good | Good | Excellent | Good | Good | Good |
| Example 8 | Good | Good | Excellent | Good | Good | Good |
| Example 9 | Good | Good | Excellent | Good | Good | Good |
| Example 10 | Good | Good | Excellent | Good | Good | Good |
| Example 11 | Good | Excellent | Excellent | Good | Good | Good |
| Example 12 | Good | Excellent | Excellent | Good | Good | Good |
| Example 13 | Excellent | Fair | Excellent | Good | Good | Good |
| Comparative | Fair | Fair | Good | Fair | Good | Poor |
| Example 1 | | | | | | |
| Comparative | Fair | Fair | Good | Fair | Good | Poor |
| Example 2 | | | | | | |
| Comparative | The ink separated into oil and water layers | | | | | |
| Example 3 | (unmeasurable) | | | | | |
| Comparative | Good | Good | Excellent | Fair | Fair | Poor |
| Example 4 | | | | | | |
| Comparative | Good | Good | Excellent | Fair | Poor | Poor |
| Example 5 | | | | | | |
| Comparative | Good | Good | Excellent | Fair | Fair | Poor |
| Example 6 | | | | | | |
| Comparative | Fair | Excellent | Excellent | Fair | Poor | Poor |
| Example 7 | | | | | | |
| Comparative | Fair | Excellent | Excellent | Fair | Poor | Poor |
| Example 8 | | | | | | |

Having now fully described the invention, it will be apparent to one of ordinary skill in the art that many changes and modifications can be made thereto without departing from the spirit and scope of the invention as set forth therein.

What is claimed is:

1. An ink for inkjet recording, comprising:
a colorant;
an organic solvent;
a surfactant; and
water,
wherein the organic solvent comprises a polyol having a solubility parameter (SP value) of from 11.8 to 14.0 (components A) or an oxetane compound having the following formula (I) (components B): 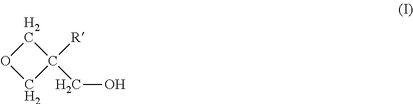
wherein R′ represents an alkyl group having 1 to 2 carbon atoms,
wherein the content of at least one member of the components A or the components B is from 30 to 70% by weight per 100% by weight of the ink, and
wherein the colorant is a hydrodispersible pigment having a functional group selected from the group consisting of —COOM, —SO₃M, —PO₃HM, —PO₃M₂, —CONM₂, —SO₃NM₂, —NH—C₆H₄—COOM, —NH—C₆H₄—SO₃M, —NH—C₆H₄—PO₃HM, —NH—C₆H₄—PO₃M₂, —NH—C₆H₄—CONM₂ and —NH—C₆H₄—SO₃NM₂, wherein M is a quaternary ammonium ion.

2. The ink for inkjet recording of claim 1, wherein the polyol which has a solubility parameter (SP value) of from 11.8 to 14.0 is a member selected from the group consisting of 1,2-butanediol, 1,3-butanediol, 2,3-butanediol, 3-methyl-1,3-butanediol, 1,2-propanediol and 1,3-propanediol.

3. The ink for inkjet recording of claim 1, wherein the hydrodispersible pigment is a black pigment, a cyan pigment, a magenta pigment, a yellow pigment or their mixtures.

4. An image forming method, comprising:
applying a stimulation selected from the group consisting of a heat, a pressure and light to the ink for inkjet recording according to claim 1 to fly and record an image.

5. An image forming apparatus, comprising:
a flyer configured to apply a stimulation selected from the group consisting of a heat, a pressure and light to the ink for inkjet recording according to claim 1 to fly and record an image.

6. An ink-recorded matter having an image recorded by the ink for inkjet recording according to claim 1.
